(19) United States
(12) Patent Application Publication
(10) Pub. No.: US 2026/0062633 A1
(43) Pub. Date: Mar. 5, 2026

(54) EMULSION

(71) Applicants: Quadrise International Limited, London (GB); Vertoro B.V., Geleen (NL)

(72) Inventors: Jason Victor MILES, London (GB); Patrick BRUNELLE, London (GB); Michael BOOT, Geleen (NL); Panagiotis KOURIS, Geleen (NL)

(21) Appl. No.: 19/107,407

(22) PCT Filed: Aug. 31, 2023
(86) PCT No.: PCT/GB2023/052255

§ 371 Date: Feb. 27, 2025

(30) Foreign Application Priority Data
Aug. 31, 2022 (GB) 2212659.3

(51) Int. Cl. C10L 1/32; B01F 23/41

(52) U.S. Cl. CPC C10L 1/328; B01F 23/4145; C10L 2250/082; C10L 2270/026; C10L 2270/04

(57) ABSTRACT

An emulsion comprising an oil phase and an aqueous phase; the emulsion comprising: from about 0.05 wt. % to about 1 wt. % of a surfactant; and from about 0.1 wt. % to about 95 wt. % of C5 carbohydrate; and/or from about 0.1 wt. % to about 95 wt. % of C6 carbohydrate; wherein the sum of the components in the emulsion does not exceed 100 wt. %.

The present invention relates to an emulsion, a fuel composition comprising or consisting of an emulsion, a process for preparing an emulsion, an emulsion obtainable by/produced by/formed from the process, and uses of said emulsions.

### BACKGROUND

Significant changes in the range and use of fuels throughout the world over the last years have influenced and altered the way that energy intensive industries source their requirements and operate. These industrial trends have been significantly affected by fuel economics, diversification and availability, as well as by an increasing need to improve environmental performance. Higher prices have resulted in a move away from conventional oil-based fuels towards cheaper alternatives with reduced environmental impact. Although some feasible primary energy alternatives to oil exist for land-based industries, some markets (such as the shipping market) remain predominantly dependent on oil-based products, particularly heavy fuel oil-based products, and is likely to do so for the foreseeable future.

Heavy fuel oils are normally produced by blending viscous refinery residues with higher value distillate fuels to provide the lower viscosity characteristics required for acceptable fuel handling and combustion performance. Direct use of high viscosity refinery residues requires high-temperature storage and handling that limits and complicates their potential use, and consequently lowers their value. As an alternative to blending refinery residues for fuel oil production, further processing (e.g. coking, hydrocracking, etc.) of the residue can be applied at the refinery to yield additional distillate fuels. However this strategy requires large capital investments to be made by the oil refinery, produces some lower value products, generates difficult to market by-products, results in an increase of emissions (including greenhouse and acid gases), all of which can serve to limit the economic advantage of this approach.

Alternative fuel products are becoming available in some specific markets. For example, biofuels and bio oils have been considered as possible alternatives to the use of exclusively fossil fuel derived oil products. In some specific examples, the use of said biofuels or bio oils may be considered to be environmentally beneficial or “green”. However, the use of such alternative fuel products comes with distinct disadvantages.

For example, many engines are not designed to run exclusively on such products and as such, machinery and vehicles need to be modified to use said products which places a significant cost burden on the user. Whilst attempts to minimise such costs include mixing alternative fuel products with conventional oils, the outcome of these endeavours is often problematic as the resulting compositions are often unstable and difficult to handle and store for extended periods of time. Furthermore, the mixing of said alternative fuel products may require large scale processing plants, the provision of which places a further cost burden on the user.

In many industries, existing infrastructure is not equipped to handle alternative fuel products and as such, transportation of said products to their intended use sites can be expensive. Furthermore, many of these alternative fuel products are difficult to produce. For example, the precursors required to make said products can be difficult to obtain or transport. As such, they can be expensive to produce and additionally cannot usually be produced near to their intended use site. As such, there remains a need for alternative fuel products in many industries (and, in particular, in the shipping industry).

### SUMMARY OF INVENTION

In one aspect, there is provided an emulsion comprising an oil phase and an aqueous phase; the emulsion comprising:
from about 0.05 wt. % to about 1 wt. % of a surfactant; and
from about 0.1 wt. % to about 95 wt. % of C5 carbohydrate; and/or
from about 0.1 wt. % to about 95 wt. % of C6 carbohydrate;
   wherein the sum of the components in the emulsion does not exceed 100 wt. %.

In some embodiments, the C5 carbohydrate is selected from the group consisting of arabinose, lyxose, ribose, xylose, ribulose, xylulose, their cyclic forms, and mixtures thereof; wherein each arabinose, lyxose, ribose, xylose, ribulose, xylulose, and any of their cyclic forms is individually unsubstituted or substituted with one or more substituent.

In some embodiments, the emulsion comprises one or more C5 carbohydrate derivatives; optionally each of the one or more C5 carbohydrate derivatives is individually selected from the group consisting of furfural, tetrahydrofuran, methyltetrahydrofuran, 2-methylfuran, 2,5-dimethylfuran, 5-hydroxymethylfurfural, furfurylalcohol, tetrahydrofurfurylalcohol, and combinations thereof.

In some embodiments, the emulsion comprises one or more degradation products or dehydration products of hemicellulose.

In some embodiments, the emulsion comprises one or more C5 carbohydrate solvents, optionally each of the one or more C5 carbohydrate solvents is individually selected from the group consisting of organic solvents, inorganic solvents and mixtures thereof.

In some embodiments, the C6 carbohydrate is selected from the group consisting of allose, altrose, glucose, mannose, gulose, idose, galactose, talose, psicose, fructose, sorbose, tagatose, their cyclic forms, and mixtures thereof; wherein each of the allose, altrose, glucose, mannose, gulose, idose, galactose, talose, psicose, fructose, sorbose, tagatose, and any of their cyclic forms is individually unsubstituted or substituted with one or more substituent.

In some embodiments, the emulsion comprises one or more C6 carbohydrate derivatives; optionally each of the one or more C6 carbohydrate derivatives is selected from the group consisting of furfural, tetrahydrofuran, methyltetrahydrofuran, 2-methylfuran, 2,5-dimethylfuran, 5-hydroxymethylfurfural, furfurylalcohol, tetrahydrofurfurylalcohol, and combinations thereof.

In some embodiments, the emulsion comprises one or more C6 carbohydrate solvents, optionally each of the one or more C6 carbohydrate solvents is individually selected from the group consisting of organic solvents, inorganic solvents and mixtures thereof.

In some embodiments, the C5 carbohydrate is comprised in the oil phase, the aqueous phase, or in both the oil phase and the aqueous phase; and/or the C6 carbohydrate is comprised in the oil phase, the aqueous phase, or in both the oil phase and the aqueous phase.

In some embodiments, the surfactant is a non-ionic surfactant, an anionic surfactant, a cationic surfactant, an amphoteric surfactant or a mixture thereof; optionally, the surfactant is selected from the group consisting of fatty alkyl amines, ethoxylated fatty alkylamines, ethoxylated fatty alkyl monoamines, methylated fatty alkyl monoamines, methylated fatty alkyl amines, quaternary fatty alkyl amines, and combinations thereof.

In some embodiments, the emulsion comprises water in an amount from about 1 wt. % to about 95 wt. % and wherein the sum of the components in the emulsion does not exceed 100 wt. %. In some embodiments, the emulsion comprises an oil in an amount from about 1 wt. % to about 99 wt. % and wherein the sum of the components in the emulsion does not exceed 100 wt. %.

In some embodiments, the oil phase comprises or consists of:
(i) a hydrocarbon residue derived from one or more of; processed heavy crude oil or natural bitumen; refinery atmospheric distillation; refinery vacuum distillation; refinery visbreaking, thermal cracking or steam cracking; refinery cat-cracking; refinery hydroprocessing and hydrocracking; and de-asphalting processes; or combinations thereof;
(ii) a hydrocarbon residue selected from those having Chemical Abstracts Service (CAS) Registry Numbers 8052-42-4, 64741-45-3, 64741-56-6, 64741-67-9, 64741-75-9, 64741-80-6, 64742-07-0, 64742-78-5, 64742-85-4, 68748-13-7, 68783-13-1, 70913-85-8, 91995-23-2 or 92062-05-0, or combinations thereof;
(iii) a heavy fuel oil, a residual fuel oil, or combinations thereof;
(iv) a biofuel, a bio oil or combinations thereof; and/or
(v) combinations of any of (i), (ii), (iii) and/or (iv).

In some embodiments, the emulsion comprises an alcohol in an amount from about 0.05 wt. % to about 70 wt. % and wherein the sum of the components in the emulsion does not exceed 100 wt. %.

In some embodiments, the emulsion comprises a polymeric stabiliser in an amount from about 0.01 wt. % to about 0.5 wt. % and wherein the sum of the components in the emulsion does not exceed 100 wt. %.

In some embodiments, the emulsion comprises an acid in an amount from about 0.01 wt. % to about 5 wt. % and wherein the sum of the components in the emulsion does not exceed 100 wt. %; optionally wherein the acid is selected from organic acids, inorganic acids, and mixtures thereof.

In some embodiments, the oil phase is dispersed in the aqueous phase. In some embodiments, the aqueous phase is dispersed in the oil phase.

In some embodiments, the emulsion has a droplet size (D50) of from about 0.1 m to about 100 μm. In some embodiments, the emulsion has a droplet size (D90) of from about 0.1 μm to about 200 μm.

In some embodiments, the emulsion has a dynamic viscosity of up to 1000 mPas at 50° C. and 100 s-1, wherein the dynamic viscosity is measured as described herein. In some embodiments, the emulsion has a dynamic viscosity of up to 500 mPas at 50° C. and 100 s-1, wherein the dynamic viscosity is measured as described herein.

In one aspect, there is provided a fuel composition comprising or consisting of an emulsion as described herein; optionally wherein the fuel is a diesel fuel, a marine fuel, or a fuel oil for heat and power utility applications.

In one aspect, there is provided a process for preparing an emulsion, the process comprising the steps of: providing an oil; mixing water and a surfactant to form an aqueous solution; providing a C5 carbohydrate and/or C6 carbohydrate; and blending the oil and aqueous solution with the C5 carbohydrate and/or C6 carbohydrate under conditions sufficient to form an emulsion. In some embodiments, the emulsion is an emulsion as described herein.

In one aspect, there is provided an emulsion obtainable by/produced by/formed from a process as described herein.

In one aspect, there is provided a use of an emulsion as defined herein as a fuel.

In one aspect, there is provided a process for preparing a fuel using an emulsion as defined herein.

### BRIEF DESCRIPTION OF FIGURES

The present invention will now be described with reference to the accompanying drawings, in which:

FIG. 1 shows a schematic of a process for producing an emulsion, as described herein.

FIG. 2 shows a schematic of a process for producing an emulsion, as described herein.

FIG. 3 shows a schematic of a process for producing an emulsion, as described herein.

FIG. 4 shows a diagram of an example laboratory scale colloidal mill emulsification system, for the production of test formulation samples.

### DETAILED DESCRIPTION

The present invention relates to an emulsion, a fuel composition comprising or consisting of an emulsion, a process for preparing an emulsion, an emulsion obtainable by/produced by/formed from the process, and uses of said emulsions.

The inventors have surprisingly found that it is possible to produce an emulsion comprising an oil phase and a water phase which further comprises a C5 carbohydrate and/or a C6 carbohydrate. The resulting emulsion is stable and can be used as a fuel. This is particularly important as C5 carbohydrates and C6 carbohydrates can be easily obtained from commonly available sources (such as lignin comprising biomass). Such sources can be easily processed to provide the C5 carbohydrate and/or C6 carbohydrate which can then be incorporated into the emulsions described herein. The inventors have shown that such C5 carbohydrates and C6 carbohydrates can be incorporated into an emulsion that can be used as a fuel. The C5 carbohydrates and/or C6 carbohydrates act as calorific components of the fuel that are less expensive than conventional fuel components. The C5 carbohydrates and/or C6 carbohydrates can be produced easily and near to any use site (which is particularly important for shipping industries which often need to have fuels produced on demand near to refuelling stations which are stationed Worldwide).

The inventors have also found that C5 carbohydrates and C6 carbohydrates that are formed as described herein can be produced as part of C5 carbohydrate comprising components and C6 carbohydrate comprising components each of which may comprise components in addition to the C5 carbohydrates and C6 carbohydrates which can improve the quality and/or cost effectiveness of the emulsions produced therefrom. Accordingly, in one aspect, there is provided an emulsion comprising an oil phase and an aqueous phase; the emulsion comprising:
from about 0.05 wt. % to about 1 wt. % of a surfactant; and
from about 0.1 wt. % to about 95 wt. % of C5 carbohydrate; and/or
from about 0.1 wt. % to about 95 wt. % of C6 carbohydrate;
   wherein the sum of the components in the emulsion does not exceed 100 wt. %.

In some embodiments, the C5 carbohydrate is a C5 monosaccharide, i.e. a carbohydrate/monosaccharide that comprises 5 carbon atoms. For example, the C5 carbohydrate may be a pentose or a pentose derivative. The C5 carbohydrate may comprise one or more C5 carbohydrates.

Each C5 carbohydrate may individually be in its linear form, its cyclic form, or a mixture thereof. For example, a C5 carbohydrate may have 5 carbon atoms in the carbon backbone of its linear form. For example, a C5 carbohydrate may have 5 carbon atoms in the carbon containing ring of its cyclic form (i.e. the C5 carbohydrate is a pyranose based carbohydrate). Alternatively, a C5 carbohydrate may have 4 carbon atoms in the carbon containing ring of its cyclic form (i.e. the C5 carbohydrate is a furanose based carbohydrate) and 1 carbon atom directly attached to a carbon atom of the carbon containing ring structure (i.e. without an intermediate atom there between).

When the C5 carbohydrate is a furanose based carbohydrate, the non-ring forming carbon atom may be directly attached to any of the 4 ring forming carbon atoms.

In some embodiments, the C5 carbohydrate is selected from the group consisting of arabinose, lyxose, ribose, xylose, ribulose, xylulose, their cyclic forms, and mixtures thereof; wherein each arabinose, lyxose, ribose, xylose, ribulose, xylulose, and any of their cyclic forms is individually unsubstituted or substituted with one or more substituent. The cyclic forms of arabinose, lyxose, ribose, xylose, ribulose, xylulose are arabinopyranose, arabinofuranose, lyxopyranose, lyxofuranose, ribopyranose, ribofuranose, xylopyranose, xylofuranose, ribupyranose, ribufuranose, xylupyranose, and xylufuranose, respectively. Each of the cyclic forms may be in the D or L enantiomeric form. Each of the cyclic forms may have a or P stereochemistry.

The C5 carbohydrate may be unsubstituted or substituted with one or more substituents. When the one or more substituents comprises one or more carbon atoms, the resulting C5 carbohydrate will comprise more than 5 carbons atom. In this respect, the C5 of the C5 carbohydrate refers to the number of carbon atoms (5) in the unsubstituted C5 carbohydrate. For example, when a C5 carbohydrate is substituted with one methyl group as described herein, the C5 carbohydrate comprises 6 carbon atoms in total.

In some embodiments, the C5 carbohydrate may be substituted with one, two, three, four or five substituents; optionally one, two or three substituents. Preferably, the C5 carbohydrate is substituted with one or two substituents. Preferably, the C5 carbohydrate is substituted with one substituent.

When the C5 carbohydrate is a C5 carbohydrate substituted with one or more substituents, each of the one or more substituents may individually be selected from the group consisting of C1-10 alkyl, acetyl, amino, nitro, or cyano. Preferably, each of the one or more substituents is individually selected from the group consisting of C1-5 alkyl, acetyl, amino, nitro, or cyano. Optionally, each of the one or more substituents is individually a C1-10 alkyl group. For example, each of the one or more substituents is individually a C1 alkyl group, a C2 alkyl group, a C3 alkyl group or a C4 alkyl group.

Optionally, each of the one or more substituents is individually selected from methyl, ethyl, propyl (1-propyl or 2 propyl), and acetyl.

In some embodiments, the C5 carbohydrate is substituted with one or two substituents, each of which is individually selected from methyl, ethyl, propyl (1-propyl or 2 propyl), and acetyl.

In some embodiments, the C5 carbohydrate is a C5 carbohydrate substituted with one or more substituents and each of the one or more substituents does not comprise an ester group.

In some embodiments, the C5 carbohydrate is selected from the group consisting of methyl-pentopyranoside, methyl-D-xylopyranoside, methyl 3-O-acetylpentopyranoside and mixtures thereof.

In some embodiments, the C5 carbohydrate is a C5 oligosaccharide. The C5 carbohydrate may comprise one or more C5 oligosaccharides. When the C5 carbohydrate comprises one or more C5 oligosaccharides, each C5 oligosaccharide may individually comprise two or more C5 monosaccharide units linked by a glycosidic bond (O-glycosidic bond). Optionally, each C5 oligosaccharide may individually comprise two, three, four, five, six, seven, eight, nine, or ten C5 monosaccharide units. Preferably, each C5 oligosaccharide comprises two or three monosaccharide units (i.e. each C5 oligosaccharide is a dimer or trimer). Each of the one or more C5 monosaccharide units may individually be as described herein in relation to C5 monosaccharides. In some embodiments, each of the one or more C5 oligosaccharides is a water soluble C5 oligosaccharide.

In some embodiments, the C5 carbohydrate comprises one or more C5 oligosaccharides and one or more C5 monosaccharides as described herein.

In preferred embodiments, the C5 carbohydrate comprises or consists of two or more C5 carbohydrates as described herein. For example, the C5 carbohydrate may comprise one or more (preferably one or two) C5 monosaccharides as described herein and one or more (preferably one or two) C5 oligosaccharides as described herein. Preferably, the C5 monosaccharide is selected from those described herein and the C5 oligosaccharide is a C5 dimer or trimer.

In some embodiments, the C5 carbohydrate is an oligomer. The C5 carbohydrate may comprise one or more oligomers. When the C5 carbohydrate comprises one or more oligomers, each oligomer may individually comprise two or more C5 monosaccharide units linked by a glycosidic bond (0-glycosidic bond). Optionally, each oligomer may individually comprise two, three, four, five, six, seven, eight, nine, or ten C5 monosaccharide units. Each of the one or more C5 monosaccharide units may individually be as described herein in relation to C5 monosaccharides. In some embodiments, each of the one or more oligomers is a water soluble oligomer.

In some embodiments, the C5 carbohydrate comprises one or more C5 oligomers and one or more C5 monosaccharides as described herein.

In preferred embodiments, the C5 carbohydrate comprises or consists of two or more C5 carbohydrates as described herein. For example, the C5 carbohydrate may comprise one or more (preferably one or two) C5 monosaccharides as described herein and one or more (preferably one or two) C5 oligomers as described herein. Preferably, the C5 monosaccharide is selected from those described herein and the C5 oligomer is a C5 dimer or trimer.

Oligomers and oligosaccharides differ from polymers in that polymers have more repeat units (usually many more repeat units). The skilled person understands the difference between an oligomer/oligosaccharide and polymer.

The emulsion comprises from about 0.1 wt. % to about 95 wt. % of C5 carbohydrate, wherein the sum of the components in the emulsion does not exceed 100 wt. %.

Optionally, the emulsion comprises from about 0.1 wt. % to about 75 wt. % of C5 carbohydrate; from about 0.1 wt. % to about 70 wt. % of C5 carbohydrate; from about 0.1 wt. % to about 65 wt. % of C5 carbohydrate; from about 0.1 wt. % to about 60 wt. % of C5 carbohydrate; from about 0.1 wt. % to about 50 wt. % of C5 carbohydrate; from about 0.1 wt. % to about 40 wt. % of C5 carbohydrate; or from about 0.1 wt. % to about 30 wt. % of C5 carbohydrate; wherein the sum of the components in the emulsion does not exceed 100 wt. %.

In some embodiments, the emulsion comprises one or more C5 carbohydrate derivatives. For example, the emulsion may comprise one or more compounds that are derived from/structurally similar to a C5 carbohydrate. Optionally, each of the one or more C5 carbohydrate derivatives is selected from the group consisting of furfural, tetrahydrofuran, methyltetrahydrofuran, 2-methylfuran, 2,5-dimethylfuran, 5-hydroxymethylfurfural, furfurylalcohol, tetrahydrofurfurylalcohol, and combinations thereof. Optionally, each of the one or more C5 carbohydrate derivatives is selected from the group consisting of deoxy C5 carbohydrates, wherein the C5 carbohydrates are as defined herein.

The emulsion may comprise from about 1 wt. % to about 70 wt. % of C5 carbohydrate derivatives, wherein the sum of the components in the emulsion does not exceed 100 wt. %. The emulsion may comprise from about 1 wt. % to about 40 wt. % of C5 carbohydrate derivatives, wherein the sum of the components in the emulsion does not exceed 100 wt. %. The emulsion may comprise from about 1 wt. % to about 35 wt. % of C5 carbohydrate derivatives, wherein the sum of the components in the emulsion does not exceed 100 wt. %. The emulsion may comprise from about 1 wt. % to about 30 wt. % of C5 carbohydrate derivatives, wherein the sum of the components in the emulsion does not exceed 100 wt. %. The emulsion may comprise from about 1 wt. % to about 20 wt. % of C5 carbohydrate derivatives, wherein the sum of the components in the emulsion does not exceed 100 wt. %. The emulsion may comprise from about 1 wt. % to about 10 wt. % of C5 carbohydrate derivatives, wherein the sum of the components in the emulsion does not exceed 100 wt. %.

In some embodiments, the emulsion comprises one or more degradation products of hemicellulose or dehydration products of hemicellulose. That is, the emulsion comprises a product (compound) that is produced in the degradation of hemicellulose; and/or a product (compound) that is produced in the dehydration of hemicellulose. Optionally, the emulsion comprises one or more lignin monomers or lignin oligomers. Optionally, the emulsion comprises one or more selected from the group consisting of uronic acid, propionic acid, methoxyl acids, formic acid, levulinic acid, acetic acid and ferulic acid. Optionally, the emulsion comprises one or more selected from the group consisting of formic acid, levulinic acid, acetic acid and ferulic acid. Preferably, the emulsion comprises formic acid and/or levulinic acid. For example, the emulsion comprises formic acid and levulinic acid.

The emulsion may comprise from about 1 wt. % to about 10 wt. % of degradation products of hemicellulose, dehydration products of hemicellulose, or mixtures thereof, wherein the sum of the components in the emulsion does not exceed 100 wt. %.

In some embodiments, the C5 carbohydrate, the one or more C5 carbohydrate derivatives, or the one or more degradation products of hemicellulose or dehydration products of hemicellulose is formed from an acid solvolysis process. For example, the C5 carbohydrate, the one or more C5 carbohydrate derivatives, or the one or more degradation products of hemicellulose or dehydration products of hemicellulose is formed from a process in which a lignocellulose comprising feedstock is subjected to an acid solvolysis process.

Preferably, the C5 carbohydrate is formed from an acid solvolysis process. For example, the C5 carbohydrate is formed from a process in which a lignocellulose comprising feedstock is subjected to an acid solvolysis process.

The acid in the acid solvolysis process may be any acid suitable for producing the C5 carbohydrate, the one or more C5 carbohydrate derivatives, or the one or more degradation products of hemicellulose or dehydration products of hemicellulose. For example, the acid may be selected from the group consisting of organic acids, inorganic acids, and mixtures thereof.

Organic acids comprise at least one C—H bond, examples of which include uronic acid, propionic acid, methoxyl acids, ferulic acid, lactic acid, glycolic acid, levulinic acid, methanesulfonic acid, formic acid, acetic acid, citric acid, para-toluene sulfonic acid, and benzoic acid. Preferred organic acids include ferulic acid, lactic acid, glycolic acid, levulinic acid, methanesulfonic acid, formic acid, acetic acid, citric acid, benzoic acid, para-toluene sulfonic acid, or combinations thereof. For example, at least one (optionally all) of the acids are selected from formic acid and methanesulfonic acid.

Inorganic acids include sulphuric acid, hydrochloric acid, phosphoric acid and nitric acid.

In some embodiments, the emulsion comprises one or more C5 carbohydrate solvents, optionally each of the one or more C5 carbohydrate solvents is individually selected from the group consisting of organic solvents, inorganic solvents and mixtures thereof. A C5 carbohydrate solvent is one that solvates a C5 carbohydrate as described herein (i.e. a solvent in which a C5 carbohydrate as described herein will dissolve in to form a solution). Optionally, the C5 carbohydrate solvent is an organic solvent, optionally a polar organic solvent. For example, the C5 carbohydrate solvent may be selected from the group consisting of acetone, acetonitrile, dimethylformamide (DMF), dimelthylsulfoxide (DMSO), isopropanol, n-propanol, glycerol, water, ethanol, butanol, methanol and mixtures thereof. When the emulsion comprises a C5 carbohydrate solvent which is an inorganic solvent, the inorganic solvent may be water.

In some embodiments, the C5 carbohydrate solvent is a bio solvent/bio-based solvent (i.e. a solvent produced from a biological material). For example, the C5 carbohydrate solvent may be selected from the group consisting of bio glycerol, bio butanol, bio isopropanol, bio n-propanol, bio ethanol, bio methanol, water, and mixtures thereof.

In some embodiments, the emulsion comprises from about 0.1 wt. % to about 95 wt. % of C5 carbohydrate solvent, wherein the sum of the components in the emulsion does not exceed 100 wt. %. Optionally, the emulsion comprises from about 1 wt. % to about 40 wt. % of C5 carbohydrate solvent; from about 1 wt. % to about 30 wt. % of C5 carbohydrate solvent; from about 1 wt. % to about 20 wt. % of C5 carbohydrate solvent; from about 1 wt. % to about 10 wt. % of C5 carbohydrate solvent; from about 1 wt. % to about 5 wt. % of C5 carbohydrate solvent; or from about 1 wt. % to about 3 wt. % of C5 carbohydrate solvent; wherein the sum of the components in the emulsion does not exceed 100 wt. %.

When the C5 carbohydrate solvent is/comprises water, the amount of water in the emulsion may be the sum of the water of the water phase as described herein and the water of the C5 carbohydrate solvent.

In some embodiments, the C6 carbohydrate is a C6 monosaccharide, i.e. a carbohydrate/monosaccharide that comprises 6 carbon atoms. For example, the C6 carbohydrate may be a hexose or a hexose derivative. The C6 carbohydrate may comprise one or more C6 carbohydrates.

Each C6 carbohydrate may individually be in its linear form, its cyclic form, or a mixture thereof. For example, a C6 carbohydrate may have 6 carbons atoms in the carbon backbone of its linear form. For example, a C6 carbohydrate may have 5 carbon atoms in the carbon containing ring of its cyclic form (i.e. the C6 carbohydrate is a pyranose based carbohydrate) and 1 carbon atom directly attached to a carbon atom of the carbon containing ring (i.e. without an intermediate atom there between). Alternatively, a C6 carbohydrate may have 4 carbon atoms in the carbon containing ring of its cyclic form (i.e. the C6 carbohydrate is a furanose based carbohydrate) and 2 carbon atoms directly attached to one or more carbon atoms of the carbon containing ring (i.e. without an intermediate atom there between). When the C6 carbohydrate is a pyranose based carbohydrate, the non-ring forming carbon atom may be directly attached to any of the 5 ring forming carbon atoms. When the C6 carbohydrate is a furanose based carbohydrate, each of the 2 non-ring forming carbon atoms may be directly attached to any of the 4 ring forming carbon atoms.

In some embodiments, the C6 carbohydrate is selected from the group consisting of allose, altrose, glucose, mannose, gulose, idose, galactose, talose, psicose, fructose, sorbose, tagatose, their cyclic forms, and mixtures thereof; wherein each of the allose, altrose, glucose, mannose, gulose, idose, galactose, talose, psicose, fructose, sorbose, tagatose, and any of their cyclic forms is individually unsubstituted or substituted with one or more substituent. The cyclic forms of allose, altrose, glucose, mannose, gulose, idose, galactose, talose, psicose, fructose, sorbose, tagatose are allopyranose, allofuranose, altropyranose, altrofuranose; glucopyranose, glucofuranose, mannopyranose, mannofuranose, gulopyranose, gulofuranose, idopyranose, idofuranose, galactopyranose, galactofuranose, talopyranose, talofuranose, psicopyranose, psicofuranose, fructopyranose, fructofuranose, sorbopyranose, sorbofuranose, tagatopyranose, and tagatofuranose, respectively. Each of the cyclic forms may be in the D or L enantiomeric form. Each of the cyclic forms may have a or p stereochemistry.

The C6 carbohydrate may be unsubstituted or substituted with one or more substituents. When the one or more substituents comprises one or more carbon atoms, the resulting C6 carbohydrate will comprise more than 6 carbons atom. In this respect, the C6 of the C6 carbohydrate refers to the number of carbon atoms (6) in the unsubstituted C6 carbohydrate. For example, when a C6 carbohydrate is substituted with one methyl group as described herein, the C6 carbohydrate comprises 7 carbon atoms in total.

In some embodiments, the C6 carbohydrate may be substituted with one, two, three, four or five substituents; optionally one, two or three substituents. Preferably, the C6 carbohydrate is substituted with one or two substituents. Preferably, the substituted C6 carbohydrate is substituted with one substituent.

When the C6 carbohydrate is a C6 carbohydrate substituted with one or more substituents, each of the one or more substituents may individually be selected from the group consisting of C1-10 alkyl, C6-10 aryl (for example phenyl), acetyl, amino, nitro, or cyano. Preferably, each of the one or more substituents is individually selected from the group consisting of C1-5 alkyl, C6-10 aryl (for example phenyl), acetyl, amino, nitro, or cyano. Each C1-10 alkyl, C1-C5 alkyl or C6-10 aryl may be optionally substituted with one or more elected from the group consisting of hydroxyl, acetyl, amino, nitro, or cyano.

Optionally, each of the one or more substituents is individually a C1-10 alkyl group. For example, each of the one or more substituents is individually a C1 alkyl group, a C2 alkyl group, a C3 alkyl group or a C4 alkyl group. Optionally, each of the one or more substituents is individually selected from methyl, ethyl, propyl (1-propyl or 2 propyl), and acetyl.

In some embodiments, the C6 carbohydrate is substituted with one or two substituents, each of which is individually selected from methyl, ethyl, propyl (1-propyl or 2 propyl), and acetyl.

In some embodiments, the C6 carbohydrate is a C6 carbohydrate substituted with one or more substituents and each of the one or more substituents does not comprise an ester group.

In some embodiments, the C6 carbohydrate is selected from the group consisting of methyl-D-glucopyranoside, methyl-D-glucofuranoside and dimethyl-4-O-methyl-hexanopyroside, or mixtures thereof.

In some embodiments, the C6 carbohydrate is a C6 oligosaccharide. The C6 carbohydrate may comprise one or more C6 oligosaccharides. When the C6 carbohydrate comprises one or more C6 oligosaccharides, each C6 oligosaccharide may individually comprise two or more C6 monosaccharide units linked by a glycosidic bond (0-glycosidic bond). Optionally, each C6 oligosaccharide may individually comprise two, three, four, five, six, seven, eight, nine, or ten C6 monosaccharide units. Each of the one or more C6 monosaccharide units may individually be as described herein in relation to C6 monosaccharides. In some embodiments, each of the one or more C6 oligosaccharides is a water soluble C6 oligosaccharide. In some embodiments, the C6 oligosaccharides comprises cellobiose.

In some embodiments, the C6 carbohydrate comprises one or more C6 oligosaccharides and one or more C6 monosaccharides as described herein.

In preferred embodiments, the C6 carbohydrate comprises or consists of two or more C6 carbohydrates as described herein. For example, the C6 carbohydrate may comprise one or more (preferably one or two) C6 monosaccharides as described herein and one or more (preferably one or two) C6 oligosaccharides as described herein. Preferably, the C6 monosaccharide is selected from glucose and mannose and the C6 oligosaccharide is a C6 dimer or trimer (preferably cellobiose).

In some embodiments, the C6 carbohydrate is an oligomer. The C6 carbohydrate may comprise one or more oligomers. When the C6 carbohydrate comprises one or more oligomers, each oligomer may individually comprise two or more C6 monosaccharide units linked by a glycosidic bond (0-glycosidic bond). Optionally, each oligomer may individually comprise two, three, four, five, six, seven, eight, nine, or ten C6 monosaccharide units. Each of the one or more C6 monosaccharide units may individually be as described herein in relation to C6 monosaccharides. In some embodiments, each of the one or more oligomers is a water soluble oligomer.

In some embodiments, the C6 carbohydrate comprises one or more oligomers and one or more C6 monosaccharides as described herein.

In preferred embodiments, the C6 carbohydrate comprises or consists of two or more C6 carbohydrates as described herein. For example, the C6 carbohydrate may comprise one or more (preferably one or two) C6 monosaccharides as described herein and one or more (preferably one or two) C6 oligomers as described herein. Preferably, the C6 monosaccharide is selected from glucose and mannose and the C6 oligomer is a C6 dimer or trimer (preferably cellobiose).

Oligomers and oligosaccharides differ from polymers in that polymers have more repeat units (usually many more repeat units). The skilled person understands the difference between an oligomer/oligosaccharide and polymer.

The emulsion comprises from about 0.1 wt. % to about 95 wt. % of C6 carbohydrate, wherein the sum of the components in the emulsion does not exceed 100 wt. %. Optionally, the emulsion comprises from about 0.1 wt. % to about 75 wt. % of C6 carbohydrate; from about 0.1 wt. % to about 70 wt. % of C6 carbohydrate; from about 0.1 wt. % to about 65 wt. % of C6 carbohydrate; from about 0.1 wt. % to about 60 wt. % of C6 carbohydrate; from about 0.1 wt. % to about 50 wt. % of C6 carbohydrate; from about 0.1 wt. % to about 40 wt. % of C6 carbohydrate; or from about 0.1 wt. % to about 30 wt. % of C6 carbohydrate; wherein the sum of the components in the emulsion does not exceed 100 wt. %. Preferably, the emulsion comprises from about 0.1 wt. % to about 25 wt. % of C6 carbohydrate; from about 0.1 wt. % to about 20 wt. % of C6 carbohydrate; or from about 0.1 wt. % to about 15 wt. % of C6 carbohydrate; wherein the sum of the components in the emulsion does not exceed 100 wt. %.

In some embodiments, the emulsion comprises one or more C6 carbohydrate derivatives. For example, the emulsion may comprise one or more compounds that are derived from/structurally similar to a C6 carbohydrate. Optionally, each of the one or more C6 carbohydrate derivatives is selected from the group consisting of furfural, tetrahydrofuran, methyltetrahydrofuran, 2-methylfuran, 2,5-dimethylfuran, 5-hydroxymethylfurfural, furfurylalcohol, tetrahydrofurfurylalcohol and combinations thereof. Preferably, the emulsion comprises 5-hydroxymethylfurfural. Optionally, each of the one or more C6 carbohydrate derivatives is selected from the group consisting of deoxy C6 carbohydrates, wherein the C6 carbohydrates are as defined herein.

The emulsion may comprise from about 1 wt. % to about 70 wt. % of C6 carbohydrate derivatives, wherein the sum of the components in the emulsion does not exceed 100 wt. %. The emulsion may comprise from about 1 wt. % to about 40 wt. % of C6 carbohydrate derivatives, wherein the sum of the components in the emulsion does not exceed 100 wt. %. The emulsion may comprise from about 1 wt. % to about 35 wt. % of C6 carbohydrate derivatives, wherein the sum of the components in the emulsion does not exceed 100 wt. %. The emulsion may comprise from about 1 wt. % to about 30 wt. % of C6 carbohydrate derivatives, wherein the sum of the components in the emulsion does not exceed 100 wt. %. The emulsion may comprise from about 1 wt. % to about 20 wt. % of C6 carbohydrate derivatives, wherein the sum of the components in the emulsion does not exceed 100 wt. %. The emulsion may comprise from about 1 wt. % to about 10 wt. % of C6 carbohydrate derivatives, wherein the sum of the components in the emulsion does not exceed 100 wt. %.

In some embodiments, the C6 carbohydrate or the one or more C6 carbohydrate derivatives is formed from an acid solvolysis process. For example, the C6 carbohydrate or the one or more C6 carbohydrate derivatives is formed from a process in which a lignocellulose comprising feedstock is subjected to an acid solvolysis process.

Preferably, the C6 carbohydrate is formed from an acid solvolysis process. For example, the C6 carbohydrate is formed from a process in which a lignocellulose comprising feedstock is subjected to an acid solvolysis process.

The acid in the acid solvolysis process may be any acid suitable for producing the C6 carbohydrate or the one or more C6 carbohydrate derivatives. For example, the acid may be selected from the group consisting of organic acids, inorganic acids, and mixtures thereof.

Organic acids comprise at least one C—H bond, examples of which include uronic acid, propionic acid, methoxyl acids, ferulic acid, lactic acid, glycolic acid, levulinic acid, methanesulfonic acid, formic acid, acetic acid, citric acid, para-toluene sulfonic acid, and benzoic acid. Preferred organic acids include ferulic acid, lactic acid, glycolic acid, levulinic acid, methanesulfonic acid, formic acid, acetic acid, citric acid, benzoic acid, para-toluene sulfonic acid, or combinations thereof. For example, at least one (optionally all) of the acids are selected from formic acid and methanesulfonic acid.

Inorganic acids include sulphuric acid, hydrochloric acid, phosphoric acid and nitric acid.

Preferably, the acid solvolysis process is followed by an acid hydrolysis process. For example, the acid solvolysis process produces a cellulose comprising feedstock at least a portion of which is then subjected to an acid hydrolysis process. For example, the acid in the acid hydrolysis process may be the same or different to the acid of the acid solvolysis process. For example, the acid of the acid hydrolysis process is methanesulfonic acid or sulphuric acid. Preferably, the acid of the acid hydrolysis process is sulphuric acid.

Optionally, the acid solvolysis process is followed by an enzymatic hydrolysis process. For example, the acid solvolysis process produces a cellulose comprising feedstock at least a portion of which is then subjected to an enzymatic hydrolysis process.

In some embodiments, the emulsion comprises one or more C6 carbohydrate solvents, optionally each of the one or more C6 carbohydrate solvents is individually selected from the group consisting of organic solvents, inorganic solvents and mixtures thereof. A C6 carbohydrate solvent is one that solvates a C6 carbohydrate as described herein (i.e. a solvent in which a C6 carbohydrate as described herein will dissolve in to form a solution). Optionally, the C6 carbohydrate solvent is an organic solvent, optionally a polar organic solvent. For example, the C6 carbohydrate solvent may be selected from the group consisting of acetone, acetonitrile, dimethylformamide (DMF), dimelthylsulfoxide (DMSO), isopropanol, n-propanol, glycerol, water, butanol, ethanol, methanol and mixtures thereof. When the emulsion comprises a C6 carbohydrate solvent which is an inorganic solvent, the inorganic solvent may be water.

In some embodiments, the C6 carbohydrate solvent is a bio solvent/bio-based solvent (i.e. a solvent produced from a biological material). For example, the C6 carbohydrate solvent may be selected from the group consisting of bio glycerol, bio butanol, bio isopropanol, bio n-propanol, bio ethanol, bio methanol, water, and mixtures thereof.

In some embodiments, the emulsion comprises from about 0.1 wt. % to about 95 wt. % of C6 carbohydrate solvent, wherein the sum of the components in the emulsion does not exceed 100 wt. %. Optionally, the emulsion comprises from about 1 wt. % to about 40 wt. % of C6 carbohydrate solvent; from about 1 wt. % to about 30 wt. % of C6 carbohydrate solvent; from about 1 wt. % to about 20 wt. % of C6 carbohydrate solvent; from about 1 wt. % to about 10 wt. % of C6 carbohydrate solvent; from about 1 wt. % to about 5 wt. % of C6 carbohydrate solvent; or from about 1 wt. % to about 3 wt. % of C6 carbohydrate solvent; wherein the sum of the components in the emulsion does not exceed 100 wt. %.

When the C6 carbohydrate solvent is/comprises water, the amount of water in the emulsion may be the sum of the water of the water phase as described herein and the water of the C6 carbohydrate solvent.

In some embodiments, the C5 carbohydrate is comprised in the oil phase, the aqueous phase, or in both the oil phase and the aqueous phase. In some embodiments, the C5 carbohydrate is comprised in the oil phase, and the oil phase is comprised in the water phase. For example, the C5 carbohydrate may form dispersed droplets within the oil phase of an oil-in-water emulsion. In some embodiments, the C6 carbohydrate is comprised in the oil phase, the aqueous phase, or in both the oil phase and the aqueous phase. In some embodiments, the C6 carbohydrate is comprised in the oil phase, and the oil phase is comprised in the water phase. For example, the C6 carbohydrate may form dispersed droplets within the oil phase of an oil-in-water emulsion.

### Water

In some embodiments, the emulsion comprises water in an amount from about 1 wt. % to about 95 wt. % and wherein the sum of the components in the emulsion does not exceed 100 wt. %. Optionally, the emulsion comprises from about 1 wt. % to about 75 wt. % of water; from about 1 wt. % to about 65 wt. % of water; from about 1 wt. % to about 60 wt. % of water; from about 1 wt. % to about 50 wt. % of water; from about 1 wt. % to about 40 wt. % of water; from about 1 wt. % to about 30 wt. % of water; from about 1 wt. % to about 20 wt. % of water; or from about 1 wt. % to about 10 wt. % of water; wherein the sum of the components in the emulsion does not exceed 100 wt. %.

The water in the aqueous phase can come from a variety of sources. An example of a water specification that can be used is given in Table 1.

TABLE 1
Example of water specification for emulsion production

| Parameter | Value |
|---|---|
| Suspended solids | Less than 10 mg/l and Filtered to 35 μm |
| Chlorides, mg/l | Less than 50 |
| Alkali metals, mg/l | Less than 20 |
| Alkaline earth metals, mg/l | Less than 30 |
| Silicon as SiO₂, mg/l | Less than 40 |
| pH | 6.5 to 8 |
| Total hardness | Max 6°dH |

Optionally, the water can be pretreated, for example by filtration and/or deionization.

### Oil

In some embodiments, the emulsion comprises an oil in an amount from about 1 wt. % to about 99 wt. % and wherein the sum of the components in the emulsion does not exceed 100 wt. %. Optionally, the emulsion comprises an oil in an amount up to about 70 wt. %, wherein the sum of components in the emulsion does not exceed 100 wt. %. Optionally, the emulsion comprises an oil in an amount up to about 60 wt. % or about 50 wt. %, wherein the sum of components in the emulsion does not exceed 100 wt. %.

In some embodiments, the emulsion comprises an oil in an amount from about 30 wt. % to about 70 wt. %, from about 40 wt. % to about 70 wt. %, or from about 50 wt. % to about 70 wt. %, and wherein the sum of the components in the emulsion does not exceed 100 wt. %. Optionally, the emulsion comprises an oil in an amount from about 30 wt. % to about 60 wt. %, or from about 40 wt. % to about 50 wt. %, and wherein the sum of the components in the emulsion does not exceed 100 wt. %.

In some embodiments, the oil/oil phase comprises or consists of:
(i) a hydrocarbon residue derived from one or more of; processed heavy crude oil or natural bitumen; refinery atmospheric distillation; refinery vacuum distillation; refinery visbreaking, thermal cracking or steam cracking; refinery cat-cracking; refinery hydroprocessing and hydrocracking; and de-asphalting processes; or combinations thereof;
(ii) a hydrocarbon residue selected from those having Chemical Abstracts Service (CAS) Registry Numbers 8052-42-4, 64741-45-3, 64741-56-6, 64741-67-9, 64741-75-9, 64741-80-6, 64742-07-0, 64742-78-5, 64742-85-4, 68748-13-7, 68783-13-1, 70913-85-8, 91995-23-2 or 92062-05-0, or combinations thereof;
(iii) a heavy fuel oil, a residual fuel oil, or combinations thereof;
(iv) a biofuel, a bio oil or combinations thereof; and/or
(v) combinations of any of (i), (ii), (iii) and/or (iv).

A biofuel or bio oil may be any fuel or oil that is derived from biomass. For example, the biofuel or bio oil may be derived from plant or algae material or animal waste. In some embodiments, the bio oil is derived from thermochemical and/or thermocatalytic treatment of biomass, for example biomass materials such as agricultural crops, algal biomass, municipal wastes, agricultural and forestry by-product, and woody biomass.

In some embodiments, the biofuel/bio oil may comprise biomass oils, seed oils, biomass pyrolysis oils, hydrotreated biomass pyrolysis oils, hydrotreated fatty acids (and methyl esters thereof), hydrotreated seed oils, hydrotreated aromatic oxygenated bio oils, fatty acids, methyl esters of fatty acids, algae oil, or combinations thereof. For example, the biofuel/bio oil comprises used cooking oil, used cooking oil methyl ester or combinations thereof.

The oil phase of the emulsions may comprise hydrocarbons. Typically, the oil is a source of heavy hydrocarbons, which may have a density slightly lower to significantly higher than water (e.g. 0.95 to 1.15 kg/m³ or 0.95 to 1.25 kg/m³ at 15° C.). The heavy hydrocarbon may have an extremely high viscosity. For example, the viscosity can be up to 300 000 cSt at 100° C. It can employ residues or hydrocarbon sources which have viscosities of 7 cSt or more at 25° C., or 10 cSt or more at 100° C. Hydrocarbon sources having viscosities of 180 cSt or more at 25° C., and preferably 250 cSt or more at 25° C., can also be utilised. The oil-phase hydrocarbons can be sourced from a number of established processes, including:
processed natural heavy crude oil or natural bitumen (typically after de-sanding, de-salting, de-watering)
refinery atmospheric distillation
refinery vacuum distillation
refinery visbreaking or thermal cracking or steam cracking
refinery cat-cracking (thermal and catalytic)
refinery hydroprocessing and hydrocracking
de-asphalting processes.

In one embodiment the emulsion comprises an oil phase which is a hydrocarbon residue, e.g. being sourced from refinery residues with kinematic viscosities of up to 300 000 cSt at 100° C., and preferably above 200 cSt at 100° C., and more preferably above 1 000 cSt at 100° C.

Examples of suitable hydrocarbon residues that can be used in the emulsion of the present invention are given in Table 2.

TABLE 2
Examples of hydrocarbon residues

| Residue Type | CAS RN | Description |
|---|---|---|
| Asphalt | 8052-42-4 | Combination of high molecular |
| | | weight oil derived compounds |
| | | with high proportion of |
| | | carbon numbers >C25. |
| Residue (petroleum), | 64741-45-3 | A residue produced from the |
| atm. Tower | | atmospheric distillation of |
| | | crude oil. Combination of |
| | | high molecular weight oil |
| | | derived compounds with high |
| | | proportion of carbon |
| | | numbers >C20, and boiling |
| | | at >350° C. (662° F.). |
| Residue (petroleum), | 64741-56-6 | A residue produced from the |
| vacuum | | vacuum distillation of |
| | | residue coming from the |
| | | atmospheric distillation of |
| | | crude oil. Combination of |
| | | high molecular weight |
| | | oil derived compounds with |
| | | high proportion of carbon |
| | | numbers >C34, and boiling |
| | | at >495° C. (923° F.). |
| Residue (petroleum), | 64741-67-9 | A residue produced from the |
| catalytic reformer | | distillation of product |
| fractionator | | derived from a catalytic |
| | | reformer process. Combination |
| | | of high molecular weight oil |
| | | derived compounds with high |
| | | proportion of carbon numbers |
| | | C10-C25, and boiling range |
| | | 160-400° C. (320-725° F.). |
| Residue (petroleum), | 64741-75-9 | A residue produced from the |
| hydrocracker | | distillation of product |
| | | derived from a hydrocracking |
| | | process. Combination of high |
| | | molecular weight oil derived |
| | | compounds with high |
| | | proportion of carbon |
| | | numbers >C20, and |
| | | boiling >350° C. (662° F.). |
| Residue (petroleum), | 64741-80-6 | A residue produced from the |
| thermal cracked | | distillation of product derived |
| | | from a thermal cracking |
| | | process. Combination of high |
| | | molecular weight oil derived |
| | | compounds with high proportion |
| | | of carbon numbers >C20, and |
| | | boiling >350° C. (662° F.). |
| Raffinates | 64742-07-0 | Combination of hydrocarbons |
| (petroleum), residual | | obtained as the solvent |
| oil decarbonation | | insoluble fraction from C5-C7 |
| | | solvent decarbonisation of a |
| | | residue with high proportion |
| | | of carbon numbers >C34, and |
| | | boiling >495° C. (923° F.). |
| Residue (petroleum), | 64742-78-5 | A residue produced from treating |
| hydrodesulphurised | | an atmospheric tower residue with |
| atmospheric | | hydrogen (in the presence of a |
| | | catalyst), primarily to remove |
| | | sulphur. Combination of high |
| | | molecular weight oil derived |
| | | compounds with high proportion |
| | | of carbon numbers >C20, and |
| | | boiling >350° C. (662° F.). |
| Residue (petroleum), | 64742-85-4 | A residue produced from |
| hydrodesulphurised | | treating an vacuum tower |
| atmospheric | | residue with hydrogen (in |
| | | the presence of a catalyst), |
| | | primarily to remove sulphur. |
| | | Combination of high molecular |
| | | weight oil derived compounds |
| | | with high proportion of carbon |
| | | numbers >C34, and |
| | | boiling >495° C. (923° F.). |
| Residue (petroleum), | 68748-13-7 | A residue produced from the |
| catalytic reformer | | distillation of catalytic |
| fractionator residual | | reformer process residue. |
| distillation | | Combination of high molecular |
| | | weight oil derived compounds with |
| | | that boil >399° C. (750° F.). |
| Residue (petroleum), | 68783-13-1 | Combination of hydrocarbons |
| coker scrubber | | obtained as the residual |
| condensed ring | | fraction from the distillation |
| aromatic containing | | of vacuum residue and the |
| | | products from a thermal |
| | | cracking process, with high |
| | | proportion of carbon |
| | | numbers >C20, and |
| | | boiling >350° C. (662° F.). |
| Residue (petroleum), | 70913-85-8 | A residue produced by the solvent |
| solvent extracted | | extraction of a vacuum distillate |
| vacuum distilled | | of a residue from the atmospheric |
| atmospheric residue | | distillation of crude oil |
| Asphaltenes | 91995-23-2 | Combination of hydrocarbons |
| (petroleum), | | obtained as a complex solid |
| | | black product by the separation |
| | | of petroleum residue by means |
| | | of a special treatment of a |
| | | light hydrocarbon cut. The |
| | | carbon/hydrogen ratio is |
| | | especially high. |
| Residue (petroleum), | 92062-05-0 | Combination of hydrocarbons |
| thermally cracked | | obtained from the vacuum |
| vacuum | | distillation of the products |
| | | from a thermal cracking process, |
| | | with high proportion of carbon |
| | | numbers >C34, and |
| | | boiling >495° C. (923° F.). |

An example hydrocarbon residue that can be used is given in Table 3.

TABLE 3
Example of hydrocarbon residue

| | Typical VDU, visbreaker or vacuum flashed |
|---|---|
| Property | visbreaker residue. |
| Viscosity, cSt | max. 150,000 at 100° C. |
| Density g/ml | max. 1.08 at 15° C. |
| Sulphur, % wt. | max. 3.5 |
| Al/Si content, ppm | max. 10 |
| P-value (if applicable) | min. 1.05 |
| Filterable solids | None |

### Chemical Additives

The emulsion of the present invention comprises a surfactant and optionally glycerol. In some embodiments the emulsion may additionally comprise one or more acids. In some embodiments, the emulsion may additionally comprise a polymeric stabiliser. In some embodiments, the emulsion may additionally comprise an alcohol selected from the list consisting of C₁ to C₁₀ mono or di hydric alcohols.

The chemical additives are typically added to the aqueous phase before mixing with the oil phase when preparing the emulsion. The chemical additives may alternatively/additionally be added to the oil phase before being mixed with the aqueous phase when preparing the emulsion. The glycerol may be added to the oil phase or the aqueous phase, or both. The C₁ to C₁₀ mono or di hydric alcohol may be added to the oil phase or the aqueous phase, or both. The acid may be added to the oil phase or the aqueous phase, or both.

The chemical additives can be provided separately, or two or more additives can be provided in the form of a pre-prepared chemical additive package.

### Surfactants

The emulsion comprises from about 0.05 wt. % to about 1 wt. % of a surfactant. In some embodiments, the surfactant is a non-ionic surfactant, an anionic surfactant, a cationic surfactant, an amphoteric surfactant or a mixture thereof.

In some embodiments, the surfactant is selected from the group consisting of fatty alkyl amines, ethoxylated fatty alkylamines, ethoxylated fatty alkyl monoamines, methylated fatty alkyl monoamines, methylated fatty alkyl amines, quaternary fatty alkyl amines, and combinations thereof.

The surfactant is typically added to the aqueous phase before being mixed with the oil phase when preparing the emulsion. The surfactant may alternatively/additionally be added to the oil phase before being mixed with the aqueous phase when preparing the emulsion. In some embodiments, in which glycerol is present in the oil phase, the surfactant may also be added to the oil phase.

The surfactant is present in an amount ranging from about 0.05 wt. % to about 1 wt. % of the emulsion. One aim of the surfactant is to act as an emulsifier, to stabilise the oil phase droplets in the aqueous phase. A range of from about 0.05 wt. % to about 0.5 wt. % surfactant may be used, for example about 0.08 wt. % to about 0.4 wt %.

A number of surfactants can be employed. There can be one surfactant or a combination of more than one surfactant. At least one surfactant, optionally all the surfactants, may be selected from one or more of the following:
fatty alkyl amines according to the formula;

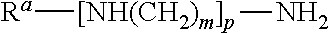

where;
R^{a} is an aliphatic group having 12 to 24 carbon atoms (preferably 12-14, 14-16, 16-18, 18-20, 20-22 or 22-24 carbon atoms)
m is a number 2 or 3
p is a number 0 to 3
ethoxylated fatty alkyl amines according to the formula;

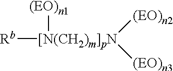

where;
R^{b} is an aliphatic group having from 12 to 24 carbon atoms (preferably 12-14, 14-16, 16-18, 18-20, 20-22 or 22-24 carbon atoms)
m is a number 2 or 3
p is a number 1 to 3
n1, n2 and n3 are each independently a number within the range greater than 0 to 70, for example from 2 to 70, or from 3 to 70. In one embodiment, n1+n2+n3 is a number greater than 0 and up to 210. Each of n1, n2 and n3 may or may not be an integer.

Ethoxylated fatty alkyl monoamines according to the formula;

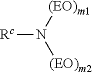

where;
R^{c} is an aliphatic group having from 12 to 24 carbon atoms (preferably 12-14, 14-16, 16-18, 18-20, 20-22 or 22-24 carbon atoms)
m1 and m2 are each a number within the range greater than 0 and up to 70, for example from 2 to 70, or from 3 to 70. In one embodiment, m1+m2 is a number greater than 0 and up to 140. Each of m1 and m2 may or may not be an integer.

Methylated fatty alkyl monoamines according to the formula;

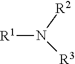

where;
one or two of the groups R¹, R², and R³ are each independently selected from aliphatic groups having from 8 to 22 carbon atoms (preferably 8-10, 10-12, 12-14, 14-16, 16-18, 18-20 or 20-22 carbon atoms)
the remaining groups of R¹, R², and R3 are methyl;
methylated fatty alkyl amines according to the formula;

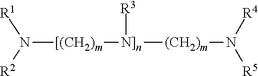

where;
one or two of the groups R¹ to R⁵ are independently selected from aliphatic groups having from 8 to 22 carbon atoms (preferably 8-10, 10-12, 12-14, 14-16, 16-18, 18-20 or 20-22 carbon atoms)
the remaining groups of R¹ to R⁵ are methyl
n is an integer from 1 to 5
m is 2 or 3,
or according to the formula;

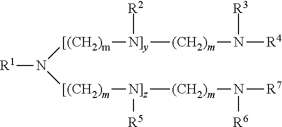

where;
one or two of the groups R¹ to R⁷ are each selected from aliphatic groups having from 8 to 22 carbon atoms (preferably 8-10, 10-12, 12-14, 14-16, 16-18, 18-20 or 20-22 carbon atoms)
the remaining groups of R¹ to R⁷ are methyl
m is 2 or 3
y and z are integers from 0 to 4, and (y+z) is 0 to 4;
or according to the formula;

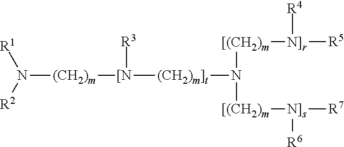

where;
one or two of the groups R¹ to R7 are an aliphatic group containing 8 to 22 carbon atoms (preferably 8-10, 10-12, 12-14, 14-16, 16-18, 18-20 or 20-22 carbon atoms) the remaining groups of R¹ to R⁷ are methyl
m is 2 or 3
t is between 0 to 3
r and s are between 1 to 4, and (t+r+s) is between 2 to 5;
and;
quaternary fatty alkyl amines according to the formula;

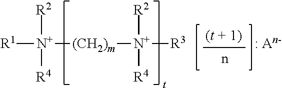

where;
R₁ is an aliphatic group having 12 to 24 carbon atoms (preferably 12-14, 14-16, 16-18, 18-20, 20-22, or 22-24 carbon atoms), e.g. —(CH₂)_{y}—CH₃, optionally comprising a carbonyl group adjacent to the nitrogen atom, i.e. —C(O)—(CH₂)_{(y-1)}—CH₃, where y is from 10 to 22 (preferably y is 10-12, 12-14, 14-16, 16-18, 18-20 or 20-22);
R² and R3 are independently at each occurrence selected from H or an aliphatic group having from 1 to 6 carbon atoms, preferably from 1 to 3 carbon atoms, and more preferably 1 carbon atom;
R⁴ is selected from H or a C₁₋₄ aliphatic group;
m is 2 or 3;
t is from 0 to 4
A is an anion;
n is the valence of the anion.

The aliphatic groups mentioned in the formulae above, including those containing a carbonyl group, can optionally be substituted, typically with one or more, for example from 1 to 3, substituents which are independently selected from hydroxyl, C₁₋₃ alkyl, C₁₋₃ alkoxy, or C₁₋₃ hydroxyalkyl. Preferably, there are no substituents on the aliphatic groups. Each aliphatic group can be saturated, or can comprise double or triple carbon-carbon bonds, for example up to 6 double bonds, for example up to 3 double bonds.

Preferably, R¹ has a formula C₁₄₋₂₀H₂₄₋₄₁, or C(O)C₁₃₋₁₉H₂₂₋₃₉. More preferably it has a formula C₁₄₋₂₀H₂₄₋₄₁.

Preferably, each R² and R3 is independently selected from CH₃, H and CH₂CH₂OH.

Preferably, each R⁴ is independently selected from CH₃ and H.

Examples of fatty alkyl amines include:
quaternary fatty alkyl monoamines according to the formula;

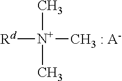

where;
R^{d} is an aliphatic group having 12 to 24 carbon atoms (preferably 12-14, 14-16, 16-18, 18-20, 20-22, or 22-24 carbon atoms)
A is an anion;
and
quaternary fatty alkyl diamines according to the formula;

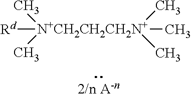

where;
R^{d} is an aliphatic group having 12 to 24 carbon atoms (preferably 12-14, 14-16, 16-18, 18-20, 20-22, or 22-24 carbon atoms)
A is an anion
n is the valence of the anion;

In the above, the anion A is preferably selected from those anions which bind more strongly to the quaternary amine than carbonate. Examples include halide, particularly Cl⁻, and organic anions such as formate (HCOO⁻), acetate (CH₃COO⁻) and methane sulfonate (CH₃SO₃⁻).

In the above, the group “EO” is an ethoxylate group (—CH₂CH₂O—). The ethoxylate group (or polyether group for more than one linked ethoxylate group) is typically terminated by H, i.e. —CH₂CH₂OH.

In embodiments, the surfactant is selected from one or more fatty alkyl di-, tri- and tetra-amines, ethoxylated fatty alkyl mono-, di- and tri-amines, and quaternary fatty alkyl amines.

In further embodiments, the surfactant is selected from one or more fatty alkyl diamines, fatty alkyl tetra-amines, ethoxylated fatty alkyl diamines, and quaternary fatty alkyl amines. Examples include fatty alkyl tripropylenetetramine, such as tallow tripropylenetetramine, fatty alkyl propylene diamines, oleyldiamine ethoxylate.

The term “fatty alkyl” includes not only saturated groups (i.e. C₁₂ to C₂₄ alkyl groups, preferably C₁₂₋₁₄, C₁₄₋₁₆, C₁₆₋₁₈, C₁₈₋₂₀, C₂₀₋₂₂ or C₂₂₋₂₄), but also partially unsaturated C₁₂ to C₂₄ groups (i.e. C₁₂ to C₂₄ alkenyl groups, preferably C₁₂₋₁₄, C₁₄₋₁₆, C₁₆₋₁₈, C₁₈₋₂₀, C₂₀₋₂₂ or C₂₂₋₂₄), for example having up to six C═C double bonds. Preferred fatty alkyl groups have no more than 3 double bonds. Examples of fatty alkyl groups include oleyl (C18, 1 double bond), and other groups associated with tallow, e.g. palmityl (C16, 0 double bonds), stearyl (C18, no double bonds), myristyl (C14, no double bonds), palmitoleyl (C16, 1 double bond), linoleyl (C18, 2 double bonds) and linolenyl (C18, 3 double bonds). The term “fatty alkyl” includes both natural and synthetic alkyl groups, for example synthetic alkyl groups may comprise C₁₅ or C₁₇. Examples of suitable fatty alkyl groups include C₁₂, C₁₃, C₁₄, C₁₅, C₁₆, C₁₇ and C₁₈ groups, each of which may be fully saturated or may comprise one or more double bonds.

The surfactant may be selected based on the composition of the aqueous phase, the oil phase and/or the emulsion as a whole. For example, the surfactant may be selected to ensure that the components of the aqueous phase or oil phase are soluble with each other. For example, the surfactant may be selected to ensure that the components of the phase containing the C₁ to C₁₀ mono or di hydric alcohol are soluble with each other.

### Alcohol

In some embodiments, the emulsion comprises an alcohol. When the emulsion comprises an alcohol, the emulsion comprises an alcohol in an amount from about 0.05 wt. % to about 70 wt. % and wherein the sum of the components in the emulsion does not exceed 100 wt. %.

In some embodiments, an alcohol selected from the list consisting of C₁ to C₁₀ mono or di hydric alcohols may be included in the emulsion. For example, the alcohol may be comprised in the oil phase and/or the aqueous phase. For example, the alcohol may be comprised in the aqueous phase. For example, the alcohol may be comprised in the oil phase. For example, the alcohol may be comprised in the oil phase and the aqueous phase. Preferably, the alcohol is comprised in the aqueous phase.

In some embodiments, the emulsion comprises glycerol in an amount from about 0.5 wt. % to about 70 wt %, wherein the sum of the components in the emulsion does not exceed 100 wt. %. In some embodiments, the glycerol is derived from a renewable carbon source. “Renewable carbon source” or “Biomass” as used herein refers to an organic material carbon source which originates from plants, trees and crops. The term may include both carbon sources from dedicated energy crops, and from residues generated in the processing of crops for food or other products. Glycerol derived from a renewable carbon source may be produced from renewable, vegetable crops, such as rapeseed, canola, soybean or palm.

In some embodiments, the emulsion comprises from about 20 wt. % to about 70 wt. % glycerol, wherein the sum of components in the emulsion does not exceed 100 wt. %. In some embodiments, the emulsion comprises from about 30 wt. % to about 70 wt. % glycerol, wherein the sum of components in the emulsion does not exceed 100 wt. %.

In some embodiments, the emulsion comprises from about 40 wt. % to about 70 wt. % glycerol, wherein the sum of components in the emulsion does not exceed 100 wt. %.

In some embodiments, the emulsion comprises from about 10 wt. % to 60 wt. % glycerol, wherein the sum of components in the emulsion does not exceed 100 wt %.

In some embodiments, the emulsion comprises about 40, about 50 or about 60 wt % glycerol, wherein the sum of components in the emulsion does not exceed 100 wt %.

In some embodiments, the alcohol is comprised in the glycerol containing phase (i.e. the glycerol containing phase contains the alcohol). The glycerol containing phase is the phase (e.g. the oil phase or aqueous phase) that contains the glycerol.

It has been found that when an alcohol selected from the list consisting of C₁ to C₁₀ mono or di hydric alcohols is comprised in the emulsion (for example in the glycerol containing phase), it is possible to obtain a glycerol containing phase that has a particularly favourable density. For example, it is possible to obtain a glycerol containing phase that has a density that is about +/−0.05 g/mL (for example +/−0.05 g/mL) of the oil. It has been found that such a glycerol containing phase results in the emulsion having an increased stability (for example to creaming or sedimentation).

When the term +/−0.05 g/mL is used it means that the density of the glycerol containing phase has value of +0.05 g/mL that of the density of the oil or −0.05 g/mL that of the oil. It does not mean that the glycerol containing phase has value within +/−0.05 g/mL of the oil.

In a preferred embodiment, the emulsion comprises an oil and the glycerol containing phase has a density of from +0.05 g/mL to about +0.5 g/mL or from −0.05 g/mL to about −0.5 g/mL of the oil. For example, the glycerol containing phase may have a density of from +0.05 g/mL to about +0.46 g/mL or from −0.05 g/mL to about −0.46 g/mL of the oil. For example, the glycerol containing phase may have a density of from +0.05 g/mL to about +0.3 g/mL or from −0.05 g/mL to about −0.3 g/mL of the oil. For example, the glycerol containing phase may have a density of from +0.05 g/mL to about +0.2 g/mL or from −0.05 g/mL to about −0.2 g/mL of the oil. For example, the glycerol containing phase may have a density of from +0.05 g/mL to about +0.1 g/mL or from −0.05 g/mL to about −0.1 g/mL of the oil. For example, the glycerol containing phase may have a density of from +0.05 g/mL to about +0.08 g/mL or from −0.05 g/mL to about −0.08 g/mL of the oil. In these embodiments, the density is measured at storage temperature.

In a preferred embodiment, the emulsion comprises an oil and the glycerol containing phase has a density of from +0.05 g/mL to about +0.5 g/mL of the oil. For example, the glycerol containing phase may have a density of from +0.05 g/mL to about +0.46 g/mL of the oil. For example, the glycerol containing phase may have a density of from +0.05 g/mL to about +0.3 g/mL of the oil. For example, the glycerol containing phase may have a density of from +0.05 g/mL to about +0.2 g/mL of the oil. For example, the glycerol containing phase may have a density of from +0.05 g/mL to about +0.1 g/mL of the oil. For example, the glycerol containing phase may have a density of from +0.05 g/mL to about +0.08 g/mL of the oil. In these embodiments, the density is measured at storage temperature.

In a preferred embodiment, the emulsion comprises an oil and the glycerol containing phase has a density of from −0.05 g/mL to about −0.5 g/mL of the oil. For example, the glycerol containing phase may have a density of from −0.05 g/mL to about −0.46 g/mL of the oil. For example, the glycerol containing phase may have a density of from −0.05 g/mL to about −0.3 g/mL of the oil. For example, the glycerol containing phase may have a density of from −0.05 g/mL to about −0.2 g/mL of the oil. For example, the glycerol containing phase may have a density of from −0.05 g/mL to about −0.1 g/mL of the oil. For example, the glycerol containing phase may have a density of from −0.05 g/mL to about −0.08 g/mL of the oil. In these embodiments, the density is measured at storage temperature. The storage temperature is between 2° and 40° C. Preferably, the storage temperature is 30° C.

The emulsion according to any preceding embodiment may comprise from about 0.5 to about 70 wt % of an alcohol selected from the list consisting of C₁ to C₁₀ mono or di hydric alcohols, wherein the sum of components in the emulsion does not exceed 100 wt %. For example, the emulsion may comprise from about 1 to about 60 wt %, from about 1 to about 50 wt %, from about 1 to about 40 wt %, from about 1 to about 30 wt %, or from about 1 to about 25 wt % of an alcohol selected from the list consisting of C₁ to C₁₀ mono or di hydric alcohols, wherein the sum of components in the emulsion does not exceed 100 wt %. In some embodiments, the emulsion may comprise from about 2 to about 25 wt % of an alcohol selected from the list consisting of C₁ to C₁₀ mono or di hydric alcohols, wherein the sum of components in the emulsion does not exceed 100 wt %.

For example, the emulsion may comprise about 2, about 10, about 15, about 20, or about 25 wt. % of an alcohol selected from the list consisting of C₁ to C₁₀ mono or di hydric alcohols, wherein the sum of components in the emulsion does not exceed 100 wt %.

In some embodiments, the C₁ to C₁₀ mono or di hydric alcohol is a linear or branched C₁ to C₁₀ mono or di hydric alcohol. In some embodiments, the alcohol is selected from the list consisting of C₁ to C₆ mono or di hydric alcohols. In some embodiments, the C₁ to C₆ mono or di hydric alcohol is a linear or branched C₁ to C₆ mono or di hydric alcohol. In some embodiments, the alcohol is selected from the list consisting of C₁ to C₄ mono or di hydric alcohols. In some embodiments, the C₁ to C₄ mono or di hydric alcohol is a linear or branched C₁ to C₄ mono or di hydric alcohol.

In some embodiments, the alcohol is selected from the list consisting of C₁ to C₁₀ mono hydric alcohols, C₁ to C₆ mono hydric alcohols, or C₁ to C₄ mono hydric alcohols. The C₁ to C₄ mono hydric alcohol may be methanol, ethanol, propanol, or butanol. For example, the di hydric alcohol may be ethylene glycol. For example, the alcohol may be selected from methanol, ethanol, or butanol (for example 1-butanol, iso-butanol, sec-butanol, or tert-butanol).

In some embodiments, the C₁ to C₁₀ mono or di hydric alcohol may refer to two or more (for example two, three or four) alcohols each individually selected from the list consisting of C₁ to C₁₀ mono or di hydric alcohols.

In some embodiments, the emulsion according to any embodiment described herein may comprise from about 0.5 to about 70 wt % of a second alcohol individually selected from the list consisting of C₁ to C₁₀ mono or di hydric alcohols provided that the sum of C₁ to C₁₀ mono or di hydric alcohols in the emulsion is from about 1 to about 70 wt % and the sum of components in the emulsion does not exceed 100 wt %. For example, the emulsion may comprise a first alcohol (for example methanol) and a second alcohol (for example ethanol) provided that the sum of the C₁ to C₁₀ mono or di hydric alcohols in the emulsion is from about 1 to about 70 wt % and the sum of components in the emulsion does not exceed 100 wt %.

In some embodiments, the ratio of glycerol:alcohol in the glycerol containing phase is from about 20:1 to about 1:5, for example, from about 38:2 to about 1.5:2.5. In some embodiments, the ratio of glycerol:alcohol in the glycerol containing phase is about 38:2, about 3:10; about 2.5:1.5; about 2:2, or about 1.5:2.5.

In some embodiments, glycerol containing phase has a density of between 0.8 g/mL and about 1.3 g/mL (measured at 25° C. and using the method described in ISO 15212-1).

### Polymeric Stabiliser

In some embodiments, one or more polymeric stabilisers may be added to the aqueous phase when preparing the emulsions. In some embodiments, the emulsion comprises a polymeric stabiliser in an amount from about 0.01 wt. % to about 0.5 wt. % and wherein the sum of the components in the emulsion does not exceed 100 wt. %. They are preferably included in amounts of up to 0.25 wt % of the emulsion. In embodiments, they are present in amounts in the range of from 0.01 to 0.10 wt %.

Polymeric stabilising and flow improvement agents may be used to improve static stability in storage by compensating for the density differential between the residue and aqueous phase. They can also modify the viscosity characteristics of the emulsion. The polymer stabilising additive can form a weakly ‘gelled’ structure in the aqueous additive-containing phase, which helps to improve static stability of the emulsion by holding the hydrocarbon residue droplets apart, preventing sedimentation during static storage conditions. The weak gel structure can also impart low resistance or yield to applied stress to ensure suitable low viscosity characteristics of the emulsion, for example during pumping and handling. This behaviour can also be recoverable, for example once the emulsion fuel is pumped into a tank it can recover its static stability characteristics. The polymer additive can help to achieve this by interacting with the other additives in the formulation through entanglement and bonding mechanisms, forming a molecularly structured gel.

There can be one or more than one polymeric stabiliser and flow improving agent. At least one polymeric stabiliser and flow improving agent is selected from polymers containing monomers comprising dialkylaminoalkyl acrylate or dialkylaminoalkyl methacrylate quaternary salts, or dialkylaminoalkylacrylamides or methacrylamides and their quaternary salts.

Examples of such polymeric stabilisers and flow improving agents include cationic polymers comprising at least one cationic monomer selected from the group of dialkylaminoalkyl acrylate or dialkylaminoalkyl methacrylate quaternary salts such as dimethylaminoethyl acrylate methyl chloride quaternary salt, dimethylaminoethyl acrylate methyl sulfate quaternary salt, dimethylaminoethyl acrylate benzyl chloride quaternary salt, dimethylaminoethyl acrylate sulfuric acid salt, dimethylaminoethyl acrylate hydrochloric acid salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, or dialkylaminoalkylacrylamides or methacrylamides and their quaternary salts such as acrylamidopropyltrimethylammonium chloride, dimethylaminopropyl acrylamide methyl sulfate quaternary salt, dimethylaminopropyl acrylamide methyl saulfate quaternary salt, dimethylaminopropyl acrylamide sulfuric acid salt, dimethylaminopropyl acrylamide hydrochloride salt, methacrylamidopropyltrimethylammonium chloride, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate, diallyldimethylammonium chloride, and diallyldimethylammonium chloride.

Additional polymeric stabilisers and flow improving agents may be selected from one or more alkyl hydroxyalkyl cellulose ethers (water soluble), preferably having an alkyl group with 1 to 3 carbon atoms, and an hydroxyalkyl group (e.g., hydroxyethyl or hydroxypropyl), where;
DS_{alkyl} is in the range of from 0.1 to 2.5;
MS_{hydroxyalkyl} is in the range of from 0.2 to 4.0;
weight average molecular weight is in the range of from 100,000 to 2,000,000 Da (ideally from 800,000 to 1,600,000 Da);

Examples include methyl ethyl hydroxyethyl cellulose ether (water soluble), preferably having
DS_{methyl} in the range of from 0.3 to 1.5
DS_{ethyl} in the range of from 0.1 to 0.7
MS_{hydroxyethyl} in the range of from 0.2 to 3.0.

DS represents the degree of substitution of the specified component, and MS represents the extent of molar substitution of the specified component.

Further examples of additional polymeric stabilisers include those where (in the formula represented below) R is H, CH₃ and/or [CH₂CH₂O]ₙH.

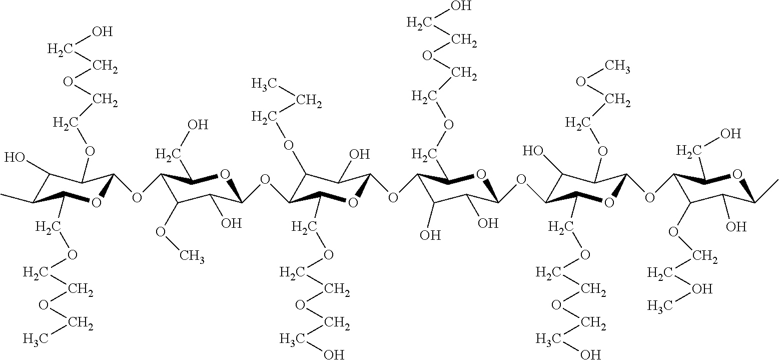

Other examples of additional polymeric stabiliser and flow improvement agent can include guar gum, starch and starch derivatives, hydroxy ethyl cellulose, and ethyl hydroxy ethyl cellulose.

### Acid

In some embodiments, the emulsion comprises an acid in an amount from about 0.01 wt. % to about 5 wt. %, and wherein the sum of the components in the emulsion does not exceed 100 wt. %, optionally wherein the acid is selected from the group consisting of organic acids, inorganic acids, and mixtures thereof. Preferably, the emulsion comprises an acid in an amount from about 0.01 wt. % to about 1 wt. %, or from about 0.01 wt. % to about 0.5 wt. %.

The acid may be added at any point in the emulsification process. For example, the acid may be added to: the water of the water phase; an aqueous solution comprising water and surfactant; and/or the oil of the oil phase. The acid may also be included in a component used in the emulsification process. For example, the acid may be comprised in a mixture of surfactant and acid; a mixture of C5 carbohydrate and acid; and/or a mixture of C6 carbohydrate and acid.

Advantageously, the acid may be comprised in a component that comprises the C5 carbohydrate, the C6 carbohydrate and/or a combination thereof. In such cases, said component may be produced comprising the amount of acid required in the final emulsion. As such, less additional acid (for example, up to and including no additional acid) may need to be added during the emulsification process.

In some embodiments, the emulsions and/or the aqueous phase have a pH of 2 to 6, and more preferably in the range 2 to 4.5, or 3 to 4.5.

In some embodiments, the emulsion has a pH of less than about 6. In some embodiments, the emulsion has a pH of from about 2 to about 6. In some embodiments, the emulsion has a pH of from about 4 to about 6. Preferably, the emulsion has a pH of from about 4 to about 5. For example, the emulsion has a pH of about 2, about 3, about 4 or about 5.

In some embodiments, the aqueous phase has a pH of less than about 6. In some embodiments, the aqueous phase has a pH of from about 2 to about 6. In some embodiments, the aqueous phase has a pH of from about 4 to about 6. Preferably, the aqueous phase has a pH of from about 4 to about 5. For example, the aqueous phase has a pH of about 2, about 3, about 4 or about 5.

The emulsions may comprise one or more organic acids. Organic acids comprise at least one C—H bond, examples of which include uronic acid, propionic acid, methoxyl acids, ferulic acid, lactic acid, glycolic acid, levulinic acid, methanesulfonic acid, formic acid, acetic acid, citric acid, para-toluene sulfonic acid, and benzoic acid.

At least one of the organic acids (optionally all) is preferably selected from ferulic acid, lactic acid, glycolic acid, levulinic acid, methanesulfonic acid, formic acid, acetic acid, citric acid, benzoic acid, para-toluene sulfonic acid, or combination thereof. Preferably, at least one (optionally all) of the acids are selected from formic acid and methanesulfonic acid.

### Emulsions

In some embodiments, the oil phase is dispersed in the aqueous phase. In some embodiments, the aqueous phase is dispersed in the oil phase.

In some embodiments, the emulsion has the following characteristics:
an average droplet size (D[4,3]) of from 1 to 100 μm;
less than 3 wt % of the droplets have a particle size of greater than 125 μm; and
a dynamic viscosity of up to 1000 mPas at 50° C. and 100 s⁻¹ wherein viscosity is measured on a Malvern Kinexus™ instrument.

In some embodiments, the emulsion has a droplet size (D50) of between about 0.1 m to about 100 μm. In some embodiments, the emulsion has a droplet size (D50) of between about 0.1 μm to about 50 μm.

In some embodiments, the emulsion has a droplet size (D90) of between about 0.1 m to about 200 μm. In some embodiments, the emulsion has a droplet size (D90) of between about 0.1 μm to about 100 μm.

In some embodiments, the emulsion has a dynamic viscosity of up to 1000 mPas at 50° C. and 100 s-1, wherein the dynamic viscosity is measured as described herein. In some embodiments, the emulsion has a dynamic viscosity of up to 500 mPas at 50° C. and 100 s-1, wherein the dynamic viscosity is measured as described herein.

The average droplet size distribution of the oil phase is measured using light scattering techniques using commercially and readily available apparatus, such as a Malvern Mastersizer™ instrument. The average droplet size is expressed as the Volume Moment Mean, represented as the D[4,3] mean. The average droplet size is suitably in the range of from 3 to 15 μm, although is preferably in the range of 5 to 10 μm.

Similar light scattering techniques and apparatus can be used to determine the droplet size distribution, and hence the weight %, of droplets with a size of greater than 125 μm based on the volume equivalent sphere diameter. Suitably, the percent of particles having a size of greater than 125 μm is less than 3 wt %. Preferably it is less than 2 wt %, and more preferably less than 1 wt %. In embodiments, less than 0.5 wt % can be achieved.

Dynamic viscosity is measured using standard techniques, and equipment such as the Malvern Kinexus™, which measures viscosity at controlled temperature and shear rates. The value is expressed in terms of mPas (cP), and is determined at a shear rate of 100 s⁻¹ and at 50° C. Suitably, the value is up to 500 mPas under such conditions, more preferably up to 300 mPas, more preferably from 50 to 300 mPas; more preferably from 100 to 300 mPas. The dynamic viscosity may be measured after manufacture of the emulsions or after storage. The emulsions provided herein exhibit dynamic stability of up to 500 mPas under the above conditions at at least one test point, e.g. after manufacture or after storage for 3 weeks at 50° C., and preferably both after manufacture and after storage for 3 weeks at 50° C. Preferably, the emulsions exhibit dynamic stability of up to 500 mPas at 50° C. and 100 s⁻¹ after manufacture or after storage for 3 weeks at 50° C.

Static stability is measured using the method defined in ASTM D6930-19 (Standard Test Method for Settlement and Storage Stability of Emulsified Asphalts).

The glycerol containing phase density is measured using any suitable method or apparatus, for example using an Anton Paar DMA 35 handheld density meter. For example, using the method defined in ISO 15212-1. Alternatively, the glycerol containing phase density can be calculated based on the components in the glycerol containing phase (for example using the density of the components and the volumetric contraction of the mixture).

In one aspect, there is provided an emulsion consisting of an emulsion as described herein.

In one aspect, there is provided a fuel composition comprising or consisting of an emulsion as defined herein; optionally wherein the fuel is a diesel fuel, a marine fuel, or a fuel oil for heat and power utility applications.

### Preparation of an Emulsion

In one aspect, there is provided a process for preparing an emulsion, the process comprising the steps of:
providing an oil;
mixing water and a surfactant to form an aqueous solution;
providing a C5 carbohydrate and/or a C6 carbohydrate; and
blending the oil and aqueous solution with the C5 carbohydrate and/or
C6 carbohydrate under conditions sufficient to form an emulsion.

In some embodiments, the emulsion is an emulsion described herein.

In one aspect, there is provided an emulsion obtainable by/produced by/formed from a process according described herein.

In some embodiments, the C5 carbohydrate is mixed with the water, the surfactant and/or the oil before the blending step. In some embodiments, the C5 carbohydrate is mixed with the water before the blending step. In some embodiments, the C5 carbohydrate is mixed with the surfactant before the blending step. In some embodiments, the C5 carbohydrate is mixed with the oil before the blending step.

In some embodiments, the C5 carbohydrate is comprised in a C5 comprising carbohydrate component. In such embodiments, the C5 carbohydrate comprising component is mixed with the water, the surfactant and/or the oil before the blending step. The C5 carbohydrate comprising component may comprise one or more selected from the group consisting of acids, C5 carbohydrate solvents, C5 carbohydrate derivatives and/or degradation products or dehydration products of hemicellulose. In this regard, each of the acids, C5 carbohydrate solvents, C5 carbohydrate derivatives, and/or degradation products or dehydration products of hemicellulose may be as described in relation to the emulsion herein.

In some embodiments, the C6 carbohydrate is mixed with the water, the surfactant and/or the oil before the blending step. In some embodiments, the C6 carbohydrate is mixed with the water before the blending step. In some embodiments, the C6 carbohydrate is mixed with the surfactant before the blending step. In some embodiments, the C6 carbohydrate is mixed with the oil before the blending step.

In some embodiments, the C6 carbohydrate is comprised in a C6 comprising carbohydrate component. In such embodiments, the C6 carbohydrate comprising component is mixed with the water, the surfactant and/or the oil before the blending step. The C6 carbohydrate comprising component may comprise one or more selected from the group consisting of acids, C6 carbohydrate solvents, C6 carbohydrate derivatives and/or degradation products or dehydration products of hemicellulose. In this regard, each of the acids, C6 carbohydrate solvents, C6 carbohydrate derivatives, and/or degradation products or dehydration products of hemicellulose

It is preferred that the chemical additives form an aqueous solution when mixed with water, although a suspension or emulsion can be tolerated provided there is sufficient mixing with the oil phase to ensure a stable emulsion results.

Examples of the oil are provided above. The oil may be heated. It is preferably heated to a temperature sufficient to reduce its viscosity to below 500 cSt, for example in the range of from 100 to 500 cSt or 200 to 500 cSt.

Preferably, it is heated to a temperature such that, when mixing with the aqueous phase, the resulting temperature at the oil-water interface will be such that the viscosity of the oil phase is less than 10000 cSt. This will depend on the heat capacities of the aqueous phase (which incorporates the chemical additives) and the oil, and also their relative concentrations.

The relationship between the temperature at the interface and the initial temperatures of the aqueous and oil phases can be expressed by the following equation:

$${T}_{aq} = {T}_{i} + \{ ( {T}_{i} - {T}_{oil} ) \times ( \frac{{C}_{o i l}}{{C}_{a q}} ) \times ( \frac{[ oil ]}{[ aq ]} ) \}$$

In the above equation:
Tᵢ=temperature at the oil/water interface of the emulsion
Tₒᵢₗ=temperature of oil phase before mixing (° C.)
T_{aq}=temperature of aqueous phase before mixing (° C.)
Cₒᵢₗ=specific heat capacity of oil phase (kJ/kg/° C.)
C_{aq}=specific heat capacity of aqueous phase (kJ/kg/° C.)
[oil]=proportion of oil phase (wt %)
[aq]=proportion of aqueous phase (wt %)

The temperature of the oil phase (Tₒᵢₗ) before mixing is preferably such that the oil viscosity is in the range of from 200-500 cSt. Although this may be dependent on the source of hydrocarbons, it is typically in a range of from 110 to 230° C.

The temperature at the oil/water interface after mixing (Tᵢ) is preferably such that the viscosity of the oil is less than 10 000 cSt. This temperature is preferably less than the boiling point of the aqueous phase, and also a temperature at which the thermal and phase stability of the chemical additives is preserved. Typically, this temperature is in the range of from 70 to 150° C., for example from 80 to 120° C.

The temperature of the aqueous phase before mixing (T_{aq}) is selected according to the above requirements of the Tᵢ and Tₒᵢₗ temperatures. Typically, it is in the range of from 30 to 95° C., for example from 50 to 90° C., or 50 to 70° C.

Mixing to form the emulsion can be achieved using apparatus and technology known to a skilled person, such as high shear mixing apparatus.

In one embodiment, two separate and different emulsions are separately prepared and mixed to form a composite emulsion, which enables further control over the properties of the desired emulsion to be achieved.

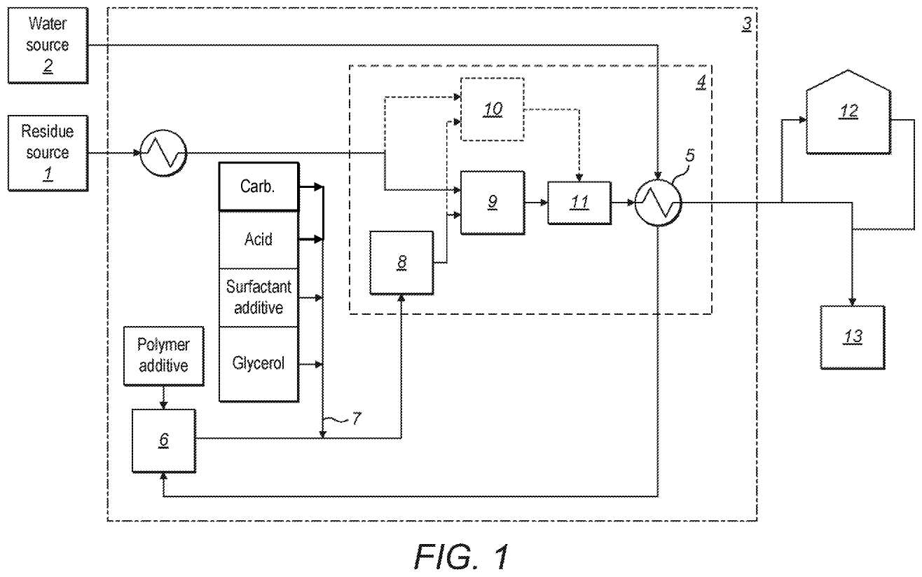

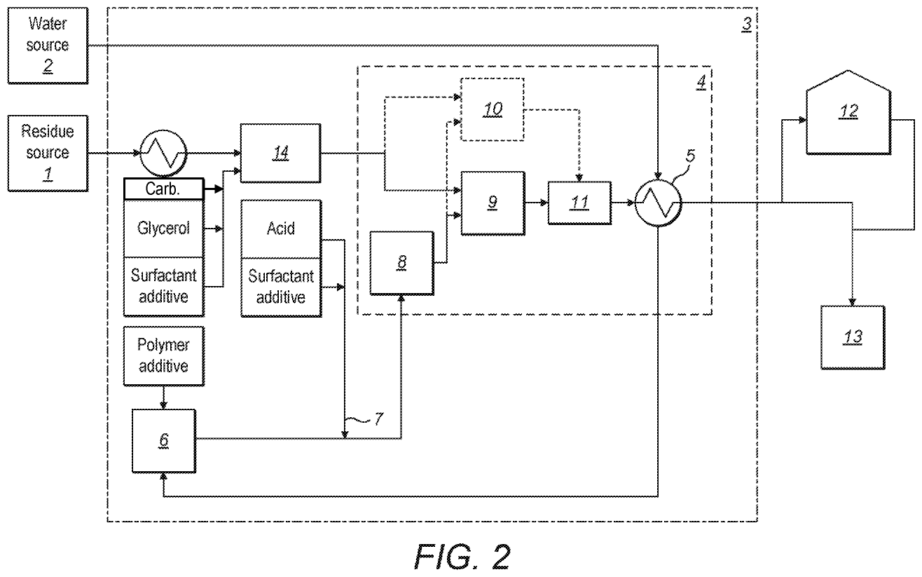

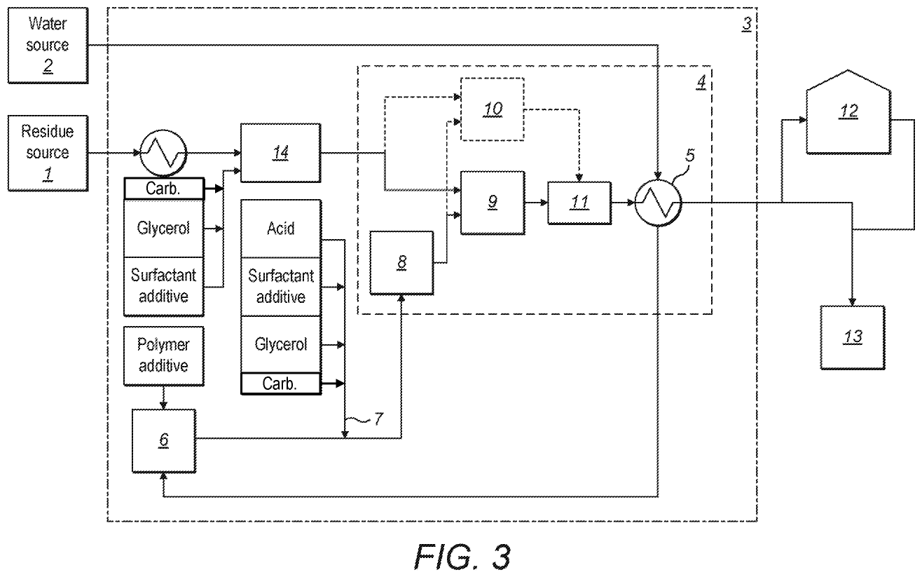

Non-limiting example schematics of a process for preparing an emulsion are given in FIGS. 1, 2 and 3. In each of FIGS. 1, 2 and 3, the boxes marked “Glycerol” represent the optional addition of glycerol. In each of FIGS. 1, 2 and 3, the boxes marked “Acid” represent the optional addition of acid. In each of FIGS. 1, 2 and 3, the boxes marked “Polymer additive” represent the optional addition of polymer additive. In FIGS. 2 and 3, there are two boxes marked “Polymer additive”. However, only one such box may be required.

The box marked “Residue source” represents a source of any oil as described herein. In FIGS. 1, 2 and 3, the boxes marked “Glycerol” may contain the C₁ to C₁₀ mono or di hydric alcohol in embodiments in which the emulsion comprises a C₁ to C₁₀ mono or di hydric alcohol. That is, the C₁ to C₁₀ mono or di hydric alcohol may be mixed with the glycerol.

In each of FIGS. 1, 2 and 3, the boxes marked “Carb.” may contain the C5 carbohydrate and/or C6 carbohydrate as described herein. In each of FIGS. 1, 2 and 3, the boxes marked “Carb.” may contain the C5 carbohydrate comprising component and/or C6 carbohydrate comprising component as described herein.

A non-limiting example schematic of a process for preparing an emulsion is given in FIG. 1. The area designated (1) represents the source of oil to be utilised as the oil phase for the production of the emulsion.

The area designated (2) represents the source of suitable water.

In the area designated (3), the material from the oil source (1) may be cooled by a medium to a suitable temperature for storage as required and further temperature control as required, to achieve a viscosity of between 250 to 500 cSt, for direct introduction into the emulsion preparation unit (4). Water (2) is first heated (typically to within the range 50 to 90° C.) in a heat exchanger (5) that is also utilised for cooling the final emulsion product (typically to less than 90° C.) along with supplementary cooling (typically to less than 60° C.) to enable easier handling.

In area (6), the polymeric stabiliser is optionally mixed into the aqueous phase, followed by the addition of the surfactant, (optional) acid, and (optional) glycerol in area (7). The chemical additives can be varied if and as required to achieve an emulsion fuel with the required specification and performance criteria.

The chemical additives (surfactant, optionally acid, optionally glycerol, optionally a C₁ to C₁₀ mono or di hydric alcohol, and optionally polymeric stabiliser) used preferably do not contain any components or impurities that can negatively affect the use of the resulting emulsion as a fuel. Therefore, preferably, they contribute no more than 50 ppm of halogenated compounds and no more than 100 ppm of alkali metals in the final emulsion fuel specification.

The aqueous phase passes through a tank/vessel (8), which provides sufficient residence time for the acid to fully activate the surfactant. Both the aqueous phase and the oil phase are then introduced into a high-shear colloidal mill (9), the speed of which is adjusted to intimately mix the components. One or more colloidal mills may be employed (10) within the manufacturing process, depending on the number of required emulsion component streams of differing properties (i.e., one for the manufacture of a single component emulsion fuel, or two or more required for the manufacture of a composite, multi-component emulsion fuel). If more than one component is manufactured, then the differing components can be passed through an in-line blender (11) or mixed downstream at the required ratios to achieve the correct properties of the final emulsion fuel. In this way, the characteristics of the final required droplet size distribution, hydrocarbon/water phase ratio (i.e. energy density) and viscosity/rheological characteristics can be effectively controlled.

After production, the emulsion fuel may be stored (12) for subsequent transport and supply for use as a fuel (13).

A non-limiting example schematic of a process for preparing an emulsion is given in FIG. 2.

In area (14), the optional glycerol and surfactant are mixed with the residue source to form the oil phase. Polymeric stabiliser is optionally mixed into the aqueous phase in area (6), followed by optionally additional surfactant and optional acid in area (7). The process then proceeds as described for FIG. 1.

A non-limiting example schematic of a process for preparing an emulsion is given in FIG. 3.

In area (14), the optional glycerol and surfactant are mixed with the residue source to form the oil phase. In area (6), the optional polymeric stabiliser is mixed into the aqueous phase, followed by the optional addition of the surfactant, optional acid, and optional glycerol in area (7). The process then proceeds as described for FIG. 1.

### Process of Hydrocarbon Residue Evaluation, Formulation and Emulsification

The formulation of the emulsion can be optimised, depending on the nature of the oil, typically a hydrocarbon residue such as one of those listed in Table 2.

The chemical additives and their concentrations that can be used for different hydrocarbon residues can be optimised by a skilled person, and preferably the components are chosen so as to ensure compliance with any associated operational, performance or legislative requirements.

### Definitions

The C5 and C6 carbohydrates described herein may be monosaccharides. The term ‘monosaccharide’ (in contrast to oligosaccharide or polysaccharide) denotes a single unit, without glycosidic connection to other such units. It includes aldoses, dialdoses, aldoketoses, ketoses and diketoses as well as deoxy sugars and amino sugars, and their derivatives. A monosaccharide may be in its linear form (e.g. a non-cyclised compound comprising a free aldehyde or ketone group) or their cyclised forms (e.g. a cyclic compound comprising a hemiacetyl group or hemiketal group).

In the description, the term “unsubstituted or substituted with one or more substituent” may mean a group/compound that is substituted or unsubstituted with at least one substituent selected from the group consisting of a deuterium atom, a halogen atom, a cyano group, a nitro group, an amine group, a silyl group, an oxy group, a thio group, a sulfinyl group, a sulfonyl group, a carbonyl group, a boron group, a phosphine oxide group, a phosphine sulfide group, an alkyl group, an alkenyl group, an alkynyl group, an alkoxy group, a hydrocarbon ring group, an aryl group, and a heterocyclic group. Optionally, each of the one or more substituents may individually be selected from the group consisting of C1-10 alkyl, C6-10 aryl, acetyl, amino, nitro, or cyano. Each C1-10 alkyl or C6-10 aryl may be optionally substituted with one or more elected from the group consisting of hydroxyl, acetyl, amino, nitro, or cyano.

Optionally, each of the one or more substituents is individually a C1-10 alkyl group. For example, each of the one or more substituents is individually a C1 alkyl group, a C2 alkyl group, a C3 alkyl group or a C4 alkyl group. Optionally, each of the one or more substituents is individually selected from methyl, ethyl, propyl (1-propyl or 2 propyl), and acetyl.

For example, when a C5 carbohydrate or a C6 carbohydrate is substituted with one or more substituents, the one or more substituents may replace one or more hydrogen atoms in the C5 carbohydrate or the C6 carbohydrate. That is, the one or more substituents may replace one or more hydrogen atoms of one or more OH groups in the C5 carbohydrate or the C6 carbohydrate.

The invention described above can be practiced in a variety of embodiments, non-limiting examples of which are described hereon.

### EXAMPLES

### Preparation of C5 and C6 Carbohydrate

A crude liquid lignin oil (CLO) was produced by treating a lignocellulosic feedstock such as a woody biomass feedstock like for instance wood chips or saw dust with a polar organic solvent in the presence of an inorganic acid and a compressed gas (such as nitrogen).

During this process, the lignocellulosic feedstock was fractioned by means of the polar organic solvent wherein the inorganic acid acted as a reagent cleaving the lignin-carbohydrate linkages present in the lignocellulosic matrix of the lignocellulosic feedstock thereby improving the release of lignin from the feedstock and the compressed gas kept the polar organic solvent in a liquid phase thereby allowing more lignin extraction and dissolution into the polar organic solvent.

The lignocellulosic feedstock together with the polar organic solvent, the inorganic acid, and the compressed gas were provided into a reactor and treated under autoclave conditions.

Experiments were conducted using birch hardwood or Douglas softwood which was fractioned in methanol, in varying biomass-to-solvent ratios, using different acids at varying acid concentrations and compressed nitrogen or hydrogen gas of 10 to 30 bar at various temperatures ranging from 140° C. to 200° C. for 30 to 120 minutes.

After the reactions, the reaction mixture was subjected to vacuum filtration to separate the crude liquid lignin oil from the cellulose pulp remainder of the solid feedstock after the fractioning. The crude liquid lignin oil comprises extracted low molecular weight oligomeric lignin fragments and some polysaccharides.

As plant cells in the woody biomass feedstock comprise typical lignin-carbohydrate interlinkages such as phenyl glycoside, benzyl ether and g-ester bonds, an efficient cleavage is required for lignin extraction and valorisation. The release of sugars, however, cannot be prevented and they may be converted to furfurals which may cause undesired repolymerisation due to lignin-furfural condensation reactions. The use of an acid hydrolysis step also releases some of the polysaccharides from the lignocellulosic matrix present in the woody biomass feedstock.

When sulfuric acid (H2SO4) was used, most of the hemicellulose was converted into methylated sugars such as methyl-pentopyranoside, methyl-D-gluconpyranoside, methyl-D-xylopyranoside, methyl 3-O-acetylpentopyranoside and dimethyl-4-O-methyl-hexanopyroside, as well as water/methanol soluble oligomeric sugars. Selectivity to the various sugars depends on the used process conditions such as solvent amount or acid severity. Methylated sugars can be separated from the lignin fragments by for instance liquid-liquid extraction using ethyl acetate or water. A high degree of delignification is always accompanied by a large extent of C5 sugars release.

The amounts and conditions used for the experiments are shown in Table 4.

TABLE 4

| | | | | | | | |
|---|---|---|---|---|---|---|---|
| | | | | | SAcid / | | |
| | WA | Methanol | Sol/WA | SAcid | WA | Temperature | |
| WT | (g) | (ml) | (g/g) | (mmol/L) | (wt. %) | and Time | CGas (bar) |

Comparative examples

| | | | | | | | | |
|---|---|---|---|---|---|---|---|---|
| CE1 | birch sawdust | 3.0 | 60 | 15.8:1 | 4 | 0.81 | 140° C., 2 h | 0 |
| CE2 | birch sawdust | 3.0 | 60 | 15.8:1 | 4 | 0.81 | 160° C., 2 h | 0 |
| CE3 | birch sawdust | 3.0 | 60 | 15.8:1 | 4 | 0.81 | 180° C., 2 h | 0 |
| CE4 | birch sawdust | 3.0 | 36 | 9.5:1 | 4 | 0.49 | 160° C., 2 h | 0 |
| CE5 | birch sawdust | 3.0 | 24 | 6.3:1 | 4 | 0.32 | 160° C., 2 h | 0 |
| CE6 | birch sawdust | 3.0 | 36 | 9.5:1 | 4 | 0.49 | 180° C., 2 h | 0 |
| CE7 | birch sawdust | 3.0 | 24 | 6.3:1 | 4 | 0.32 | 180° C., 2 h | 0 |

Examples

| | | | | | | | | |
|---|---|---|---|---|---|---|---|---|
| E1 | birch sawdust | 3.0 | 24 | 6.3:1 | 4 | 0.32 | 180° C., 2 h | 30 (H2) |
| E2 | birch sawdust | 3.0 | 24 | 6.3:1 | 4 | 0.32 | 180° C., 2 h | 30 (N2) |
| E3 | birch sawdust | 3.0 | 15 | 3.9:1 | 4 | 0.20 | 180° C., 2 h | 30 (N2) |
| E4 | birch sawdust | 4.8 | 24 | 3.9:1 | 4 | 0.20 | 180° C., 2 h | 30 (N2) |
| E5 | birch sawdust | 4.8 | 24 | 3.9:1 | 8 | 0.40 | 180° C., 2 h | 30 (N2) |
| E6 | birch sawdust | 12 | 36 | 2.3:1 | 8 | 0.24 | 180° C., 2 h | 30 (N2) |
| E7 | birch sawdust | 12 | 36 | 2.3:1 | 8 | 0.24 | 200° C., 2 h | 30 (N2) |
| E8 | birch sawdust | 200 | 1600 | 6.3:1 | 4 | 0.32 | 180° C., 2 h | 30 (N2) |
| E9 | birch sawdust | 12 | 36 | 2.3:1 | 10 | 0.30 | 180° C., 2 h | 30 (N2) |

Acid type effect

| | | | | | | | | |
|---|---|---|---|---|---|---|---|---|
| E10 | birch sawdust | 12 | 36 | 2.3:1 | 25 | 0.94 | 180° C., 2 h | 30 (N2) |
| | | | | | (H₂PO₄) | (H₃PO₄) | | |
| E11 | birch sawdust | 12 | 36 | 2.3:1 | 10 (HCl) | 0.27 | 180° C., 2 h | 30 (N2) |
| | | | | | | (HCl) | | |

Wood type

| | | | | | | | | |
|---|---|---|---|---|---|---|---|---|
| E12 | Douglas sawdust | 12 | 36 | 2.3:1 | 10 | 0.30 | 180° C., 2 h | 30 (N2) |

Pressure effect

| | | | | | | | | |
|---|---|---|---|---|---|---|---|---|
| CE8 | birch sawdust | 12 | 36 | 2.3:1 | 10 | 0.30 | 180° C., 2 h | 0 |
| E13 | birch sawdust | 12 | 36 | 2.3:1 | 10 | 0.30 | 180° C., 2 h | 10 (N2) |
| E14 | birch sawdust | 12 | 36 | 2.3:1 | 10 | 0.30 | 180° C., 2 h | 20 (N2) |
| CE6 | birch sawdust | 3.0 | 36 | 9.5:1 | 4 | 0.49 | 180° C., 2 h | 0 |
| E15 | birch sawdust | 3.0 | 36 | 9.5:1 | 4 | 0.49 | 180° C., 2 h | 30 |

Wood chips

| | | | | | | | | |
|---|---|---|---|---|---|---|---|---|
| E16 | birch chips | 3 | 24 | 6.3:1 | 4 | 0.32 | 180° C., 2 h | 30 (N2) |

Time Effect

| | | | | | | | | |
|---|---|---|---|---|---|---|---|---|
| E17 | birch sawdust | 4.8 | 24 | 3.9:1 | 8 | 0.40 | 180° C., 30 min | 30 (N2) |
| E18 | birch sawdust | 4.8 | 24 | 3.9:1 | 8 | 0.40 | 180° C., 60 min | 30 (N2) |

Solvent effect

| | | | | | | | | |
|---|---|---|---|---|---|---|---|---|
| E19 | birch sawdust | 4.8 | 24 | 3.9:1 | 8 | 0.40 | 180° C., 60 min | 30 (N2) |
| | | | (ethanol) | | | | | |

WT = Wood Type
WA = Wood amount (g)
Sol/WA = solvent (g) to Wood Amount (g)
Sacid = sulphuric acid (mmol/l)
Cgas = compressed gas (bar)

The birch sawdust and chips used in the examples and comparative examples comprise about 23.6 wt. % of lignin, whereas the Douglas sawdust comprises about 29.9 wt. % of lignin. The wood residue in the example and comparative examples was air dried at 60° C.

Samples of the resulting crude liquid lignin oil (CLO) compositions were subjected to a further isolation step to form the C5 carbohydrate comprising component and a lignin comprising component. The CLO consists mainly of sugars, like C5 and C6 methylated sugars, lignin oligomers and organic molecules like methoxyphenol components, which are obtained when the lignocellulosic solid feedstock is subjected to a depolymerisation process. The mild depolymerisation process involves the cleavage of the (relatively) weak ether linkages of the lignin rich solid feedstock and break down of lignin into lignin oligomers and sugars, mainly methylated sugars. Examples of methylated sugars are methyl-pentopyranoside, methyl-D-gluconpyranoside, methyl-D-xylopyranoside, methyl 3-O-acetylpentopyranoside, dimethyl-4-O-methyl-hexanopyroside and mixtures thereof.

The CLO is subjected to a liquid-liquid extraction step (i.e. water). CLO (40 ml) is mixed with 120 ml of demi water, followed by vigorous stirring and letting the lignin oligomers to precipitate. The resulting mixture was filtered through a gooch funnel filter. The aqueous phase can be subjected to a water evaporation step to concentrate the carbohydrates (C5, C6) to the desired concentration in water.

A C6 carbohydrate comprising component was formed by dilute acid hydrolysis of cellulose-rich feedstock. A dilute acid hydrolysis process was used to convert a cellulose residue stream (microcrystalline MCC cellulose) derived from WO2021064047 (incorporated herein by reference) into a crude sugar oil (CSO) composition. Sulphuric acid was used at low concentrations (maximum 10 wt %) and low-severity operating window (temperatures up to 200-220° C.) to hydrolyse the cellulose-rich streams into a glucose-rich CSO. Residence time of the reaction is maximum 1 hour, preferably up to 30 minutes. The residence time depends on the so called combined severity factor CS. CS depends on pH, reaction temperature and residence time. However, degradation may not be prevented. Therefore, some glucose derivatives are also present in the CSO composition. Carbohydrate derivatives/degradation products can be for example HMF, furfural, furans, levullinic acid, formic acid, acetic acid, and ferulic acid. The solution after reaction is neutralized with CaO, or Ca(OH)2 to remove sulphuric acid in the form of Ca(SO4)2 as solid. Alternatively, sodium hydroxide or calcium hydroxide can also be used. pH after neutralization was approximately pH 6-7.

Alternatively, cellulose-rich streams/feedstocks can also be used, for example cellulose-rich waste streams (cardboards, cartons, wastepaper, newspapers etc.), cellulose-pulps and residues from biorefineries, and microcrystalline MCC cellulose.

### Preparation of Emulsion

For the preparation of the aqueous phase containing the additives (surfactant, optionally acid(s), optionally polymeric stabiliser, optionally glycerol, optionally C5/C6 carbohydrate solvent if present in the aqueous phase), the following procedure can be used:

The volume of water to be used for the preparation of the test formulation is heated to between 50 to 70° C. The required amount of polymeric stabiliser (if used) is added to the hot water and mixed until completely dissolved.

If the one or more acids are used, the pH of the solution is adjusted to be within the range 2 to 6, preferably 2 to 4.5, or 3 to 4.5.

At this stage of the preparation, the amount of the surfactant, C5 carbohydrate and/or C6 carbohydrate (and optionally glycerol) are added and the water phase is mixed while the pH is adjusted using further acid until the required pH is achieved. This mixing continues until all the additives are dissolved and optionally activated.

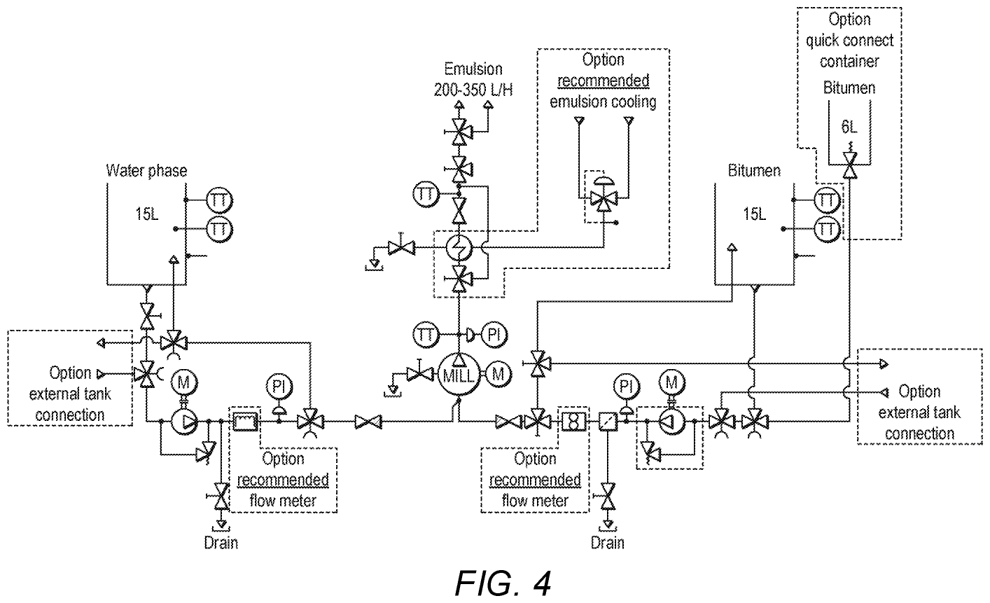

The aqueous phase is then transferred to a laboratory scale colloidal mill system (such as the DENIMOTECH™ SEP-0.3R Emulsion Research Plant which is capable of producing emulsions at a maximum capacity of 350 l/h, see FIG. 4). A quantity of the oil is then introduced into the system and heated to the required temperature as indicated above (45° C.).

Alternatively or additionally, the amount of the surfactant, the C5 carbohydrate and/or C6 carbohydrate (and optionally glycerol) are added to and mixed with the oil prior to the oil being fed to the colloid mill system.

The test emulsion can then be prepared using the following procedure; Flow of cooling water to the system outlet heat exchanger is started.

Pumping of the prepared water phase through the system via the colloidal mill is started.

The mill is switched on and a suitable mid-range speed selected (e.g., 9000 rpm for the SEP-0.3R system). The back pressure on the system is adjusted to approximately 2 bar. Once steady flows and temperatures are achieved, the hydrocarbon residue pump is started at a low flow rate, and steadily increased until the required flow rate is achieved (e.g., to give a final hydrocarbon residue content in the emulsion). The backpressure of the system is adjusted to maintain a level of approximately 2 bar. The flow rate of water to the final heat exchanger is adjusted to ensure the emulsion is flowing at the outlet of the system at a temperature less than 90° C.

Once steady state operation of the system is achieved (i.e., in terms of flow rates, temperatures and pressures) a sample of the emulsion is taken for testing and analysis. To stop production pumping of the residue through the system is stopped, and flow of the water phase maintained to flush the system through.

For the further evaluation and optimisation process the operating procedure of the laboratory scale colloidal mill system will be the same, with the required process and formulation variables being adjusted accordingly.

The principle of the production procedure for the manufacture of an emulsion fuel on a large scale using a continuous in-line plant will be the same as described above. Based on the results of these tests, further formulation matrix testing can be carried out if necessary, to fine-tune and optimise the response of the residue to emulsification and subsequent stability testing, focusing on specific aspects and variables.

Emulsions were prepared according to the above described procedure using the constituent parts in Table 5 and Table 6 and analysed using a Malvern Mastersizer™ instrument.

TABLE 5

| | | | | | | | Analysis | |
|---|---|---|---|---|---|---|---|---|
| | HFO | Water | Glycerol | AF134 | C6-A | | D50 | D90 |
| Sample | (wt. %) | (wt. %) | (wt. %) | (wt. %) | (wt. %) | pH | (μm) | (μm) |
| 1 | 68 | ~29 | 0 | 0.4 | 10 | 4 | 34.8 | 75.2 |
| 2 | 50 | ~9.7 | 40 | 0.4 | 10 | 4 | 4.8 | 12.0 |

TABLE 6

| | | | | | | | Analysis | |
|---|---|---|---|---|---|---|---|---|
| | HFO | Water | Glycerol | AF134 | C5 | | D50 | D90 |
| Sample | (wt. %) | (wt. %) | (wt. %) | (wt. %) | (wt. %) | pH | (μm) | (μm) |
| 1 | 68 | ~29 | 0 | 0.4 | 3 | 4 | 29.4 | 63.3 |
| 2 | 50 | ~7 | 40 | 0.4 | 3 | 4 | 1.5 | 3.3 |
| 3 | 50 | ~10 | 20 | 0.4 | 20 | 4 | 1.8 | 3.3 |
| 4 | 50 | ~10 | 0 | 0.4 | 40 | 4 | 4.4 | 13.6 |

TABLE 7

| | | | | | | | Analysis | |
|---|---|---|---|---|---|---|---|---|
| | HFO | Water | Glycerol | AF134 | C6-B | | D50 | D90 |
| Sample | (wt. %) | (wt. %) | (wt. %) | (wt. %) | (wt. %) | pH | (μm) | (μm) |
| 1 | 50 | ~22 | 0 | 0.4 | 40 | 4 | 2.4 | 5.2 |
| 2 | 50 | ~16 | 20 | 0.4 | 20 | 4 | 1.8 | 3.4 |
| 3 | 45 | ~21 | 20 | 0.4 | 20 | 4 | 3.7 | 7.9 |

In tables 5, 6, and 7:
pH was adjusted using formic acid.
HFO: Heavy fuel oil.
C5: C5 carbohydrate comprising component (˜95 wt. % C5 carbohydrates in aqueous mixture). The ˜5 wt. % water of the aqueous mixture is included in the total water wt. % in table 6).
C6-A: C6 carbohydrate comprising component (˜3 wt. % C6 carbohydrates in aqueous mixture). The ˜97 wt. % water of the aqueous mixture is included in the total water wt. % in table 5.
C6-B: C6 carbohydrate comprising component (˜70% wt. % C6 carbohydrates in aqueous mixture). The ˜30 wt. % water of the aqueous mixture is included in the total water wt. % in table 7.
AF134: Alkyl diamine ethoxylate.

The emulsions of the invention (e.g. those of tables 5, 6 and 7), were stable and showed no signs of creaming or sedimentation. Emulsions according to the invention are therefore particularly effective for use as fuels.

1. An emulsion comprising an oil phase and an aqueous phase; the emulsion comprising:
from about 0.05 wt. % to about 1 wt. % of a surfactant; and
from about 0.1 wt. % to about 95 wt. % of C5 carbohydrate; and/or
from about 0.1 wt. % to about 95 wt. % of C6 carbohydrate;
wherein the sum of the components in the emulsion does not exceed 100 wt. %.

2. An emulsion according to claim 1, wherein the C5 carbohydrate is selected from the group consisting of arabinose, lyxose, ribose, xylose, ribulose, xylulose, their cyclic forms, and mixtures thereof; wherein each arabinose, lyxose, ribose, xylose, ribulose, xylulose, and any of their cyclic forms is individually unsubstituted or substituted with one or more substituent.

3. An emulsion according to claim 1, wherein the emulsion comprises one or more C5 carbohydrate derivatives; optionally each of the one or more C5 carbohydrate derivatives is selected from the group consisting of furfural, tetrahydrofuran, methyltetrahydrofuran, 2-methylfuran, 2,5-dimethylfuran, 5-hydroxymethylfurfural, furfurylalcohol, tetrahydrofurfurylalcohol, and combinations thereof.

4. An emulsion according to claim 1, wherein the emulsion comprises one or more degradation products or dehydration products of hemicellulose.

5. An emulsion according to claim 1, wherein the emulsion comprises one or more C5 carbohydrate solvents, optionally each of the one or more C5 carbohydrate solvents is individually selected from the group consisting of organic solvents, inorganic solvents and mixtures thereof.

6. An emulsion according to claim 1, wherein the C6 carbohydrate is selected from the group consisting of allose, altrose, glucose, mannose, gulose, idose, galactose, talose, psicose, fructose, sorbose, tagatose, their cyclic forms, and mixtures thereof; wherein each of the allose, altrose, glucose, mannose, gulose, idose, galactose, talose, psicose, fructose, sorbose, tagatose, and any of their cyclic forms is individually unsubstituted or substituted with one or more substituent.

7. An emulsion according to claim 1, wherein the emulsion comprises one or more C6 carbohydrate derivatives; optionally each of the C6 carbohydrate derivatives is selected from the group consisting of furfural, tetrahydrofuran, methyltetrahydrofuran, 2-methylfuran, 2,5-dimethylfuran, 5-hydroxymethylfurfural, furfurylalcohol, tetrahydrofurfurylalcohol, and combinations thereof.

8. An emulsion according to claim 1, wherein the emulsion comprises one or more C6 carbohydrate solvents, optionally each of the one or more C6 carbohydrate solvents is individually selected from the group consisting of organic solvents, inorganic solvents and mixtures thereof.

9. An emulsion according to claim 1, wherein:
the C5 carbohydrate is comprised in the oil phase, the aqueous phase, or in both the oil phase and the aqueous phase; and/or
the C6 carbohydrate is comprised in the oil phase, the aqueous phase, or in both the oil phase and the aqueous phase.

10. An emulsion according to claim 1, wherein the surfactant is a non-ionic surfactant, an anionic surfactant, a cationic surfactant, an amphoteric surfactant or a mixture thereof; optionally, the surfactant is selected from the group consisting of fatty alkyl amines, ethoxylated fatty alkylamines, ethoxylated fatty alkyl monoamines, methylated fatty alkyl monoamines, methylated fatty alkyl amines, quaternary fatty alkyl amines, and combinations thereof.

11. An emulsion according to claim 1, wherein the emulsion comprises water in an amount from about 1 wt. % to about 95 wt. % and wherein the sum of the components in the emulsion does not exceed 100 wt. %.

12. An emulsion according to claim 1, wherein the emulsion comprises an oil in an amount from about 1 wt. % to about 99 wt. % and wherein the sum of the components in the emulsion does not exceed 100 wt. %.

13. An emulsion according to claim 1, wherein the oil phase comprises or consists of:
(i) a hydrocarbon residue derived from one or more of; processed heavy crude oil or natural bitumen; refinery atmospheric distillation; refinery vacuum distillation; refinery visbreaking, thermal cracking or steam cracking; refinery cat-cracking; refinery hydroprocessing and hydrocracking; and de-asphalting processes; or combinations thereof;
(ii) a hydrocarbon residue selected from those having Chemical Abstracts Service (CAS) Registry Numbers 8052-42-4, 64741-45-3, 64741-56-6, 64741-67-9, 64741-75-9, 64741-80-6, 64742-07-0, 64742-78-5, 64742-85-4, 68748-13-7, 68783-13-1, 70913-85-8, 91995-23-2 or 92062-05-0, or combinations thereof;
(iii) a heavy fuel oil, a residual fuel oil, or combinations thereof;
(iv) a biofuel, a bio oil or combinations thereof; and/or
(v) combinations of any of (i), (ii), (iii) and/or (iv).

14. An emulsion according to claim 1, wherein the emulsion comprises an alcohol in an amount from about 0.05 wt. % to about 70 wt. % and wherein the sum of the components in the emulsion does not exceed 100 wt. %.

15. An emulsion according to claim 1, wherein the emulsion comprises a polymeric stabiliser in an amount from about 0.01 wt. % to about 0.5 wt. % and wherein the sum of the components in the emulsion does not exceed 100 wt. %.

16. An emulsion according to claim 1, wherein the emulsion comprises an acid in an amount from about 0.01 wt. % to about 5 wt. % and wherein the sum of the components in the emulsion does not exceed 100 wt. %; optionally wherein the acid is selected from organic acids, inorganic acids, or mixtures thereof.

17. (canceled)

18. (canceled)

19. An emulsion according to claim 1, wherein the emulsion has a droplet size (D50) of from about 0.1 μm to about 100 μm.

20. An emulsion according to claim 1, wherein the emulsion has a droplet size (D90) of from about 0.1 μm to about 200 μm.

21. (canceled)

22. A fuel composition comprising or consisting of an emulsion as defined in claim 1; optionally wherein the fuel is a diesel fuel, a marine fuel, or a fuel oil for heat and power utility applications.

23. A process for preparing an emulsion, the process comprising the steps of:
providing an oil;
mixing water and a surfactant to form an aqueous solution;
providing a C5 carbohydrate and/or C6 carbohydrate; and
blending the oil and aqueous solution with the C5 carbohydrate and/or C6 carbohydrate under conditions sufficient to form an emulsion.

24. (canceled)

25. (canceled)
